(19) United States
(12) Patent Application Publication
(10) Pub. No.: US 2020/0286183 A1
(43) Pub. Date: Sep. 10, 2020

(54) INFORMATION PROCESSING APPARATUS, AND INFORMATION PROCESSING METHOD, AND PROGRAM

(71) Applicant: SONY CORPORATION, Tokyo (JP)

(72) Inventor: Ryosuke FURUKAWA, Tokyo (JP)

(73) Assignee: SONY CORPORATION, Tokyo (JP)

(21) Appl. No.: 16/648,915

(22) PCT Filed: Sep. 25, 2018
(86) PCT No.: PCT/JP2018/035261

§ 371 Date: Mar. 19, 2020

(30) Foreign Application Priority Data
Oct. 6, 2017 (JP) 2017-196202

(51) Int. Cl. G06Q 40/08; G07C 5/08; B60W 40/09

(52) U.S. Cl. CPC G06Q 40/08; B60W 2540/30; B60W 40/09; G07C 5/0841

(57) ABSTRACT

There is provided an information processing apparatus, an information processing method, and a program, which are capable of improving consciousness of safe driving to reduce traffic accidents using an incentive such as a discount of insurance premiums for an insurant of automobile insurance. Positional information, acceleration information, or the like is detected by a mobile device carried by a driver of a vehicle, and transmitted to a server operated by an insurer. Then, in the server, on the basis of the positional information, acceleration information, or the like, a high-accident-correlation driving act that is highly correlated to an accident is extracted among the driving acts of the driver who drives the vehicle, a driving risk tendency is calculated as evaluation of the driving acts, a display image is generated on the basis of the calculated driving risk tendency and transmitted to the mobile device to be displayed. This can be applied to a server operated by an insurer.

### TECHNICAL FIELD

The present disclosure relates to an information processing apparatus, an information processing method, and a program, and more particularly, to an information processing apparatus, an information processing method, and a program which are capable of reducing traffic accidents using telematics and consequently reducing the burden of costs on a driver who is an insurant related to automobile insurance and an insurer.

### BACKGROUND ART

Automobile insurance in the related art has been calculated according to classes based on the age of an insurant who is a driver, the mileage of a target vehicle, the year of the target vehicle, past accident records, and the like.

Here, in order to avoid an automobile accident, a driving tendency of a driver usually has a great influence. A possibility of causing an automobile accident differs greatly between a person who has a driving tendency of easily causing an accident and a person who does not.

However, in actual automobile insurance, a driver's driving tendency is not taken into consideration, and only results of an accident and the like are used as a standard for calculation. For this reason, in insurance of the related art, when conditions based on the age of a driver, the mileage of a target vehicle, the year of the target vehicle, past accident records, and the like described above are the same, insurance premiums are the same between a person who has a driving tendency of a condition that an accident easily occurs and a person who does not, in spite of a possibility of causing an automobile accident which varies greatly depending on a driving tendency.

Consequently, a technique for calculating premiums for insurance by combining a communication system with a mobile object such as an automobile and using telematics providing information in real time which is represented by navigation has become widespread. In telematics, not only does an automobile receive information but vehicle state information of an automobile can also be output to the outside. For example, a technique for obtaining the degree of driving skill of a driver of a vehicle on the basis of vehicle state information collected from an on-vehicle apparatus through a communicator and estimating insurance premiums on the basis of the obtained degree of driving skill has been proposed.

However, in a case where automobile insurance using such telematics is used, a driver who is an insurant may not be able to improve the degree of driving skill and receive benefits such as a reduction in the estimation of insurance premiums because the driver cannot know what the driver should pay attention to in order to reduce the amount of estimated insurance premiums.

Here, a technique contributing to driving assistance by determining types of risks such as “sudden steering”, “sudden braking”, and “sudden acceleration” and specifying dangerous locations on the basis of detection results of, for example, a steering wheel angle sensor, an axle speed sensor, and an inter-vehicle distance sensor which are disposed in a vehicle, and a pulse sensor and a sound collecting microphone which are worn by a driver, specifying and reflecting the types and the dangerous locations in map data, and providing the information to the driver has been proposed (see Patent Document 1).

Improving the estimation of insurance premiums using telematics by applying the technique according to Patent Document 1 to improve the degree of driving skill described above can be considered.

### CITATION LIST

### Patent Document

Patent Document 1: Japanese Patent Application Laid-Open No. 2007-47914

### SUMMARY OF THE INVENTION

### Problems to be Solved by the Invention

However, in the technique according to Patent Document 1, only dangerous locations in driving are reflected on a map, and it is not clear what kind of act affects the estimation of insurance premiums to what extent. Thus, it is not possible to know to what points attention should be paid in improving the degree of driving skill that affects the estimation of insurance premiums.

When it is not possible to efficiently improve the degree of driving skill, there is a concern that it will not be possible to effectively suppress the occurrence of a traffic accident or the like. As a result, it is not possible to reduce either of insurance premiums to be paid by an insurant and insurance money to be paid by an insurer, and thus the burden on both sides is increased.

The present disclosure was contrived in view of such circumstances. Particularly, traffic accidents are reduced by effectively improving a driver's driving skill using telematics, and consequently, the burden of costs on the driver who is an insurant related to automobile insurance and an insurer is reduced.

### Solutions to Problems

According to a first aspect of the present disclosure, there is provided an information processing apparatus including: a driving act acquisition unit that acquires information on driving acts of a driver who drives a vehicle; a high-accident-correlation driving act feature amount extraction unit that extracts a high-accident-correlation driving act that is highly correlated to an accident among the driving acts; a driving risk tendency calculation unit that calculates a driving risk tendency on the basis of the high-accident-correlation driving act; and a display image generation unit that generates a display image on the basis of the driving risk tendency calculated by the driving risk tendency calculation unit.

The driving risk tendency calculation unit may calculate an occurrence probability, a degree of contribution, and a degree of risk of the high-accident-correlation driving act as driving risk tendencies.

The driving risk calculation unit may calculate an occurrence probability of the high-accident-correlation driving act in units of time or units of mileage, calculate a degree of contribution by regression analysis of the high-accident-correlation driving act in the units of time or the units of mileage, and calculate a degree of risk on the basis of a product of the occurrence probability and the degree of contribution.

It is possible to further include a priority attention driving act selection unit that selects a high-accident-correlation driving act of which a degree of risk is in a predetermined higher rank as a priority attention driving act.

The driver may be a contractor to automobile insurance, and the information processing apparatus may further include an all-contractors high-accident-correlation driving act average occurrence probability calculation unit that calculates an average occurrence probability of high-accident-correlation driving acts of all contractors to the automobile insurance, and an all-contractors priority-attention-driving-act average occurrence probability extraction unit that extracts an average occurrence probability of all of the contractors for the priority attention driving act on the basis of the average occurrence probability of the high-accident-correlation driving acts of all of the contractors to the automobile insurance.

The driver may be a contractor to automobile insurance, and the display image generation unit may generate a display image on the basis of a degree of risk of a priority attention driving act in the driving risk tendency.

The display image generation unit may generate a display image indicating comparison between the degree of risk of the priority attention driving act in the driving risk tendency and a degree of risk corresponding to a discount rate of insurance premiums of the automobile insurance.

The display image generation unit may generate a display image in which a comment for promoting improvement in a driving act is added for a priority attention driving act in which the degree of risk of the priority attention driving act in the driving risk tendency is lower than a degree of risk that is an index of the discount rate of insurance premiums of the automobile insurance.

The discount rate of insurance premiums may be set on the basis of a function indicating that the discount rate becomes lower as the degree of risk increases and the discount rate becomes higher as the degree of risk decreases.

The display image generation unit may set a safety index on the basis of the degree of risk of the priority attention driving act and generate a display image in which the safety index is added.

The display image generation unit may include a configuration having a date-and-time designation function for designating a date and time in a display image and generate the display image indicating comparison between the degree of risk of the priority attention driving act in the driving risk tendency and a degree of risk according to the discount rate of insurance premiums of the automobile insurance at the date and time designated using the date-and-time designation function.

The display image generation unit may generate a display image in which a moving image for promoting an improvement in a driving act is added for a priority attention driving act in which the degree of risk of the priority attention driving act in the driving risk tendency is lower than a degree of risk that is an index of the discount rate of insurance premiums of the automobile insurance.

The display image generation unit may generate a display image of a traveling route of the vehicle driven by the driver and generate a display image in which a position having a degree of risk higher than a predetermined degree of risk is displayed in a predetermined color on the traveling route on the basis of information on the driving risk tendency.

It is possible to further include: a driving state accumulation unit that extracts information on driving acts of the driver who drives the vehicle and accumulates detection results of driving states of the driver; a map information acquisition unit that acquires positional information of the vehicle driven by the driver, extracts map information based on the positional information, and accumulates the extracted information in the driving state accumulation unit as the driving states; an action information acquisition unit that detects action information of the vehicle driven by the driver and accumulates the detected information in the driving state accumulation unit as the driving state; a vehicle inside and outside image information acquisition unit that detects vehicle inside and outside image information of the vehicle driven by the driver and accumulates the detected information in the driving state accumulation unit as the driving state; and a biological information acquisition unit that detects biological information of the driver and accumulates the detected information in the driving state accumulation unit as the driving state.

The positional information may be detected by a mobile device carried by the driver, and the information processing apparatus may further include a transmission unit that transmits the display image generated by the display image generation unit to the mobile device carried by the driver.

According to the first aspect of the present disclosure, there is provided an information processing method including: a driving act acquiring process of acquiring information on driving acts of a driver who drives a vehicle; a high-accident-correlation driving act extraction process of extracting a high-accident-correlation driving act that is highly correlated to an accident among the driving acts; a driving risk tendency calculation process of calculating a driving risk tendency on the basis of the high-accident-correlation driving act; and a display image generation process of generating a display image on the basis of the driving risk tendency calculated by the driving risk tendency calculation process.

According to the first aspect of the present disclosure, there is provided a program for causing a computer to function as an information processing apparatus including: a driving act acquisition unit that acquires information on driving acts of a driver who drives a vehicle; a high-accident-correlation driving act feature amount extraction unit that extracts a high-accident-correlation driving act that is highly correlated to an accident among the driving acts; a driving risk tendency calculation unit that calculates a driving risk tendency on the basis of the high-accident-correlation driving act; and a display image generation unit that generates a display image on the basis of the driving risk tendency calculated by the driving risk tendency calculation unit.

In the first aspect of the present disclosure, information of driving acts of a driver who drives a vehicle is acquired, a high-accident-correlation driving act that is highly correlated to an accident is extracted among the driving acts, a driving risk tendency is calculated on the basis of the high-accident-correlation driving act, and a display image is generated on the basis of the calculated driving risk tendency.

According to a second aspect of the present disclosure, there is provided an information processing apparatus that is carried by a driver who drives a vehicle, the information processing apparatus including: a position detection unit that detects positional information of the vehicle; a detection unit that detects an acceleration of the vehicle; and a communication unit that transmits the positional information and acceleration information to a server and acquires a display image generated by the server on the basis of the positional information and the acceleration information, in which the display image is generated on the basis of a driving risk tendency that is calculated from a high-accident-correlation driving act that is highly correlated to an accident among driving acts of the driver who drives the vehicle.

According to the second aspect of the present disclosure, there is provided an information processing method for an information processing apparatus that is carried by a driver who drives a vehicle, the information processing method including: a positional information detection process of detecting positional information of the vehicle; a detection process of detecting an acceleration of the vehicle; and a communication process of transmitting the positional information and acceleration information to a server and acquiring a display image generated by the server on the basis of the positional information and the acceleration information, in which the display image is generated on the basis of a driving risk tendency that is calculated from a high-accident-correlation driving act that is highly correlated to an accident among driving acts of the driver who drives the vehicle.

According to the second aspect of the present disclosure, there is provided a program for causing a computer that controls an information processing apparatus carried by a driver who drives a vehicle to function as: a position detection unit that detects positional information of the vehicle; a detection unit that detects an acceleration of the vehicle; and a communication unit that transmits the positional information and acceleration information to a server and acquires a display image generated by the server on the basis of the positional information and the acceleration information, in which the display image is generated on the basis of a driving risk tendency that is calculated from a high-accident-correlation driving act that is highly correlated to an accident among driving acts of the driver who drives the vehicle.

In an aspect of the present disclosure, there is provided a program in which positional information of the vehicle is detected, an acceleration of the vehicle is detected, and the positional information and acceleration information are transmitted to a server and a display image generated by the server is acquired on the basis of the positional information and acceleration information, and the display image is generated on the basis of a driving risk tendency that is calculated from a high-accident-correlation driving act that is highly correlated to an accident among driving acts of the driver who drives the vehicle.

### Effects of the Invention

According to an aspect of the present disclosure, it is possible to reduce traffic accidents particularly by effectively improving a driving technique of a driver and to further reduce the burden of costs on a driver who is an insurant related to automobile insurance and an insurer.

### BRIEF DESCRIPTION OF DRAWINGS

FIG. 1 is a diagram showing a display example using a mobile device for explaining an outline of the present disclosure.

FIG. 2 is a block diagram showing a configuration example of an information processing system of the present disclosure.

FIG. 3 is a block diagram showing a configuration example of a mobile device, a vehicle control unit, and a biological information detection unit in a vehicle shown in FIG. 2.

FIG. 4 is a block diagram showing a configuration example of a server shown in FIG. 2.

FIG. 5 is a diagram showing a flow of data between a vehicle and a server.

FIG. 6 is a block diagram showing a configuration example of an accident correlation extraction unit.

FIG. 7 is a diagram showing a high-accident-correlation driving act.

FIG. 8 is a diagram showing a display example for explaining a degree of contribution, an occurrence probability, and a degree of risk, and an evaluation image of a high-accident-correlation driving act.

FIG. 9 is a diagram showing a discount rate of insurance premiums.

FIG. 10 is a flowchart showing a driving state DB generation process.

FIG. 11 is a flowchart showing a UI/UX image display process.

FIG. 12 is a flowchart showing a driving risk calculation process in FIG. 11.

FIG. 13 is a diagram showing a modification example (Part 1) of an evaluation image.

FIG. 14 is a diagram showing a modification example (Part 1) of an evaluation image.

FIG. 15 is a diagram showing a modification example (Part 2) of an evaluation image.

FIG. 16 is a diagram showing a modification example (Part 3) of an evaluation image.

FIG. 17 is a diagram showing a modification example (Part 4) of an evaluation image.

FIG. 18 is a diagram showing a modification example (Part 5) of an evaluation image.

FIG. 19 is a diagram showing a modification example (Part 5) of an evaluation image.

FIG. 20 is a diagram showing a configuration example of a general-purpose computer.

### MODE FOR CARRYING OUT THE INVENTION

Hereinafter, (a) preferred embodiment(s) of the present disclosure will be described in detail with reference to the appended drawings. Note that, in this specification and the appended drawings, configuration elements that have substantially the same function and configuration are denoted with the same reference numerals, and repeated explanation of these configuration elements is omitted.

Hereinafter, an embodiment for implementing the present technology will be described. The description thereof will be made in the following order.

1. Outline of the Present Disclosure

2. Preferred Embodiment of the Present Disclosure

3. Modification Example (Part 1)

4. Modification Example (Part 2)

5. Modification Example (Part 3)

6. Modification Example (Part 4)

7. Modification Example (Part 5)

8. Example in which Execution is Performed Using Software

### 1. Outline of the Present Disclosure

A technique of the present disclosure presents a discount (Cash Back) of insurance premiums according to a driving act contributing to safe driving to a driver on the basis of a driving state of a driver of a vehicle in automobile insurance using telematics and presents a driving act to be noticed, in accordance with a driving state. Thereby, the technique of the present disclosure improves consciousness of safe driving to reduce traffic accidents using an incentive such as a discount of insurance premiums for a driver, and consequently, reduces the burden of insurance money on an insurer and the burden of insurance money on an insurant.

Here, automobile insurance using telematics will be described. Automobile insurance using telematics is roughly classified into two types, that is, a mileage-linked type (Pay As You Drive (PAYD)) and a type in which driving characteristics are reflected (Pay How You Drive (PHYD)). Hereinafter, automobile insurance using mileage-linked type telematics will be referred to as PAYD insurance, and automobile insurance using telematics reflecting driving characteristics will be referred to as PHYD insurance.

In the PAYD insurance, insurance premiums are set in accordance with mileage. For example, the PAYD insurance is automobile insurance in which insurance premiums increase with more mileage, and insurance premiums decrease with less mileage.

On the other hand, in the PHYD insurance, insurance premiums are set in accordance with driving characteristics. For example, the PHYD insurance is automobile insurance in which insurance premiums are higher for dangerous driving, and insurance premiums are lower for safe driving.

Since the PAYD insurance is not affected by driving characteristics, a driver who is an insurant cannot change insurance premiums even when the driver is conscious of safe driving during driving.

However, regarding the PHYD insurance, a driver pays attention to driving and improves driving characteristics by driving more safely, and thus it is possible to reduce insurance premiums. In more detail, regarding the PHYD insurance, it is possible to receive a discount (Cash Back) of insurance premiums by improving driving characteristics.

That is, in the PHYD insurance, a driver who is an insurant can receive a discount of insurance premiums as the driver who is an insurant improves driving characteristics and drives more safely. Further, by a driver who is an insurant driving more safely, it is also possible to reduce traffic accidents. As a result, an insurer's insurance money to be paid is also reduced due to a reduction in accidents, and thus the insurer can return insurance premiums to an insurant by discounting insurance premiums.

The technology of the present disclosure is applied to PHYD insurance. Consequently, hereinafter, PHYD insurance will be described in more detail.

In a case where PHYD insurance is used, for example, a dedicated application program is installed in a terminal apparatus represented by a smartphone carried by a driver. This application program causes a Global Positioning System (GPS) embedded in a terminal apparatus to detect positional information or causes a motion sensor to detect acceleration information, and transmits detection results to a server apparatus operated by an insurer. In addition, the server apparatus analyzes driving characteristics to confirm whether or not insurance premiums will be discounted in accordance with analysis results and transmits a confirmation result to the terminal apparatus, and whether or not insurance premiums will be discounted is presented to a driver in the terminal apparatus.

The driver is conscious of safe driving in order to draw out a higher discount by confirming whether or not the presented insurance premiums will be discounted. In addition, the driver increases the consciousness of safe driving to suppress the occurrence of an accident using an incentive such as a discount of insurance premiums, and thus payment of insurance money by an insurer is reduced, which leads to a discount of insurance premiums and a return to an insurant.

In other words, traffic accidents are reduced by promoting safe driving so that a driver is conscious of a discount of insurance premiums, and it is possible to reduce the burden of insurance premiums on an insurant and the burden of insurance money on an insurer.

As a result, it is possible to reduce traffic accidents and reduce an economic burden on an insurant and an insurer by promoting PHYD insurance.

However, it is unclear how driving characteristics are evaluated in promoting PHYD insurance. Therefore, there is a possibility that a driver who is an insurant will not sufficiently trust whether or not proper evaluation such as a discount of insurance premiums is obtained even when keeping safe driving in mind.

Further, even when a discount using telematics is presented, it is not clear what driving acts are evaluated highly among driving characteristics. Therefore, there is a concern that the driver cannot understand driving acts to be noted in order to increase a discount rate, that is, keep safe driving in mind.

Based on this, in the present disclosure, how driving characteristics are evaluated is clearly shown to a driver, and driving acts to be noted are clearly presented to individual drivers.

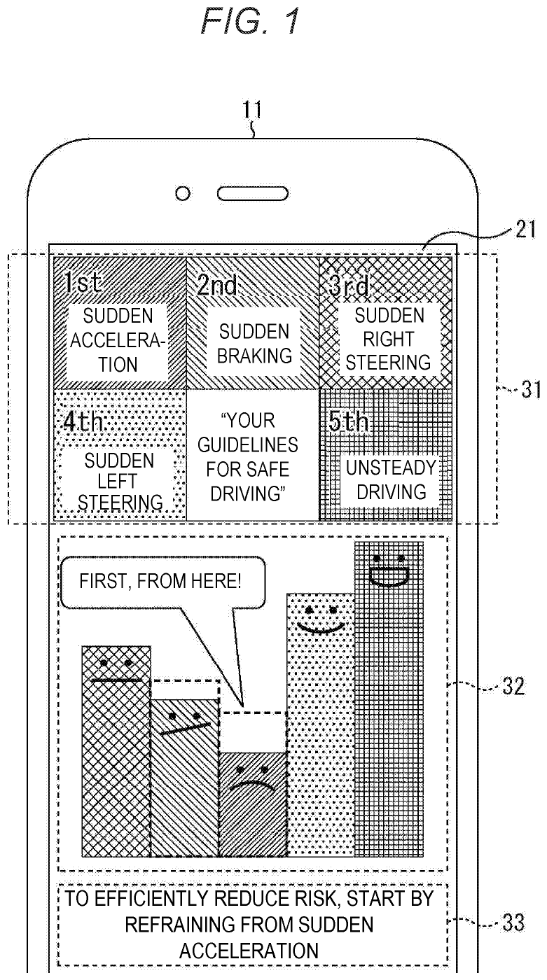

Thereby, for example, as shown in FIG. 1, individual drivers are specifically caused to be conscious of driving acts to be noted that are required for discounted insurance premiums, so that it is possible to promote safe driving and suppress the occurrence of traffic accidents, thereby reducing the burden of insurance premiums on an insurant and the burden of insurance money on an insurer.

FIG. 1 is a display example in which display is performed on a display unit 21 of a mobile device 11 carried by a driver.

The mobile device 11, which is carried by a driver when the driver drives an automobile, detects positional information detected during driving and driving state information such as an acceleration and transmits the information to a server operated by an insurer not shown in the drawing.

In the server operated by an insurer not shown in the drawing, driving state information is analyzed, it is confirmed whether or not insurance premiums will be discounted in accordance with an analysis result, a display image for presenting driving acts to which a driver should pay attention in accordance with the analysis result of the driving state is generated, and the generated display image is transmitted to the mobile device 11. In addition, the mobile device 11 displays the display image transmitted from the server.

FIG. 1 shows a display example of a display image for presenting a discount of insurance premiums according to an analysis result obtained by analyzing driving state information, and driving acts to which a driver should pay attention in accordance with an analysis result of a driving state.

In the display example of FIG. 1, a display column 31 in which driving acts to be noted are displayed in an upper portion of the display unit 21 of the mobile device 11 is displayed. In addition, a display column 32 in which evaluation results of the driving acts to be noted are displayed as bar graphs is provided below the display column 31. Further, a display column 33 in which a comment for the evaluation results is displayed is provided below the display column 32.

In the display column 31 of FIG. 1, “your guidelines for safe driving” is displayed in the lower center, and a driver's guidelines for safe driving are displayed. In addition, “1th” to “5th” are displayed from the left to the right at the upper stage and in the left and right portions at the lower stage, and the top first to fifth ranks of driving acts to be noted are displayed.

In the display column 31 of FIG. 1, a driving act of a first rank is “sudden acceleration”, a driving act of a second rank is “sudden braking”, a driving act of a third rank is “sudden right steering”, a driving act of a fourth rank is “sudden steering”, and a driving act of a fifth rank is “unsteady driving”.

Further, in the display column 32, an evaluation result for each of the driving acts of “sudden acceleration”, “sudden braking”, “sudden right steering”, “sudden steering”, and “unsteady driving” is displayed using bar graphs from the left. In addition, an evaluation standard for obtaining a discount is displayed as a dashed line for “sudden acceleration” and “sudden braking” of the bar graph in the display column 32. Thereby, the driver can recognize how much the evaluation for “sudden acceleration” and “sudden braking” has to be increased to obtain a discount.

Further, in the display column 33, “to efficiently reduce risk, start by refraining from sudden acceleration,” is displayed, and it is possible to prompt the driver to know what should be noted during driving in order to reduce risk and to present to the driver what should be performed in order to discount insurance premiums. Correspondingly, in the display column 32, a call display for making it easy to recognize a driving act to be noted, such as “first, from here!” is performed for the graph of “sudden acceleration”.

In the present disclosure, a driver's consciousness of safe driving is improved by realizing such a technique, thereby reducing traffic accidents. As a result, the payment of insurance money by an insurer is reduced, thereby realizing a discount of insurance money for a driver who is an insurant.

### 2. Preferred Embodiment of the Present Disclosure

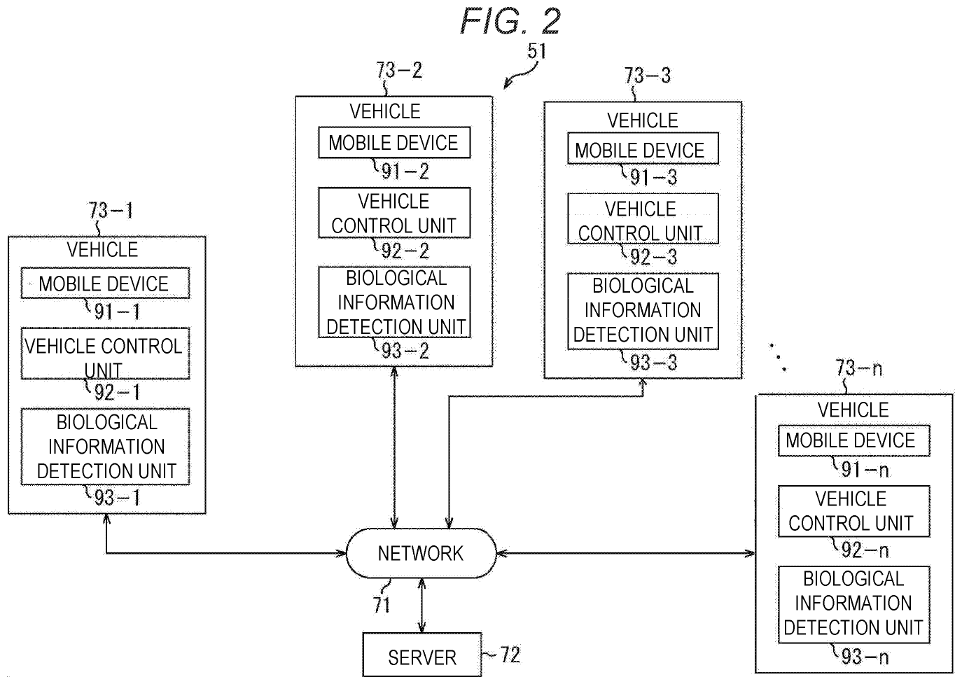

FIG. 2 shows a configuration example according to a preferred embodiment of an information processing system of the present disclosure.

An information processing system 51 shown in FIG. 2 includes a network 71, a server 72, mobile devices 91-1 to 91-n carried by drivers who are in vehicles 73-1 to 73-n, respectively, vehicle control units 92-1 to 92-n that control the vehicles 73-1 to 73-n, and biological information detection units 93-1 to 93-n that detect biological information of the drivers.

Moreover, in a case where it is not necessary to particularly distinguish between the vehicles 73-1 to 73-n, between the mobile devices 91-1 to 91-n, between the vehicle control units 92-1 to 92-n, and between the biological information detection units 93-1 to 93-n, these will be simply referred to as a vehicle 73, a mobile device 91, a vehicle control unit 92, and a biological information detection unit 93.

The mobile device 91, which is a portable terminal represented by a smartphone carried by a driver, detects positional information of a user, that is, a driver who is an insurant, and driving state information such as an acceleration, and transmits the detected information to the server 72 operated by an insurer through the network 71 constituted by a public line, a wireless local area network (LAN), or the like. In addition, the mobile device 91 receives and presents a display image constituted by a user interface/user experience (UI/UX) image regarding a discount of insurance premiums generated in accordance with a driving state by the server 72 or evaluation results according to a driving state.

The vehicle control unit 92 detects driving state information such as the speed of the vehicle 73 and transmits the detected information to the server 72 through the network 71.

The biological information detection unit 93 detects various pieces of biological information such as a heartbeat and a blood pressure of a driver and transmits the detected information to the server 72 through the network 71 as driving state information.

The server 72 acquires various pieces of driving state information transmitted from the mobile device 91, the vehicle control unit 92, and the biological information detection unit 93 through the network 71. In addition, the server 72 analyzes a driver's driving act on the basis of the acquired various pieces of driving state information, sets an evaluation value constituted by a degree of risk to be described later to set a discount of insurance premiums according to the evaluation value, generates a display image constituted by a UI/UX image based on evaluation results, and transmits the generated display image to the mobile device 91.

The mobile device 91 displays the display image as shown in, for example, FIG. 1.

Thereby, the driver can confirm what should be noted during driving in order to reduce risk, that is, what should be performed in order to discount insurance premiums. Therefore, safe driving is promoted using an incentive such as a discount of insurance premiums to reduce accidents, a burden related to the payment of insurance money by an insurer which is associated with a reduction in accidents, and the burden of premiums of insurance money of the driver who is an insurant.

<Configuration Example of Mobile Device, Vehicle Control Unit, and Biological Information Detection Unit in Vehicle>

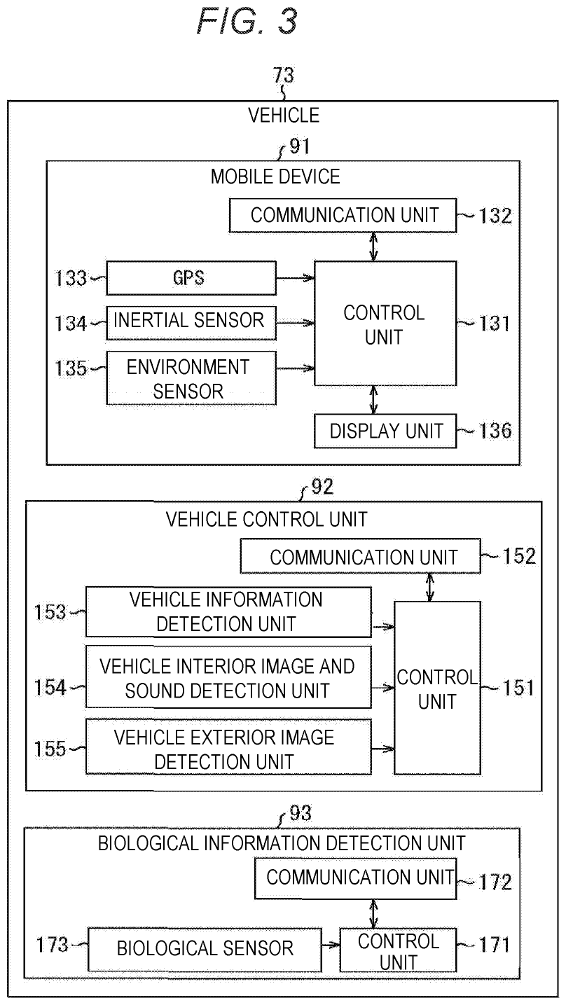

Next, a configuration example of the mobile device 91 carried by a driver who drives the vehicle 73, the vehicle control unit 92 that controls the vehicle 73, and the biological information detection unit 93 that detects biological information of a driver will be described with reference to FIG. 3. Moreover, the mobile device 91 and the biological information detection unit 93 are held by the driver. Therefore, in FIG. 3, a configuration in which the components are included in the vehicle 73 is shown, but any of electrical and physical connection to the vehicle 73 is not essential.

(Configuration Example of Mobile Device 91)

The mobile device 91, which is, for example, a portable terminal such as a smartphone and is a device carried by a driver, includes a control unit 131, a communication unit 132, a Global Positioning System (GPS) 133, an inertial sensor 134, an environment sensor 135, and a display unit 136. The mobile device detects various pieces of information and transmits the detected information to the server 72.

The control unit 131 is constituted by a processor, a memory, or the like and controls the overall operation of the mobile device 91.

The communication unit 132 is controlled by the control unit 131, and transmits and receives data and programs to and from the server 72 or another communication apparatus through the network 71 constituted by a mobile phone public line, Bluetooth (registered trademark), a wireless LAN, or the like.

The GPS 133 is controlled by the control unit 131 and communicates with a satellite not shown in the drawing. The GPS detects information constituted by a latitude and a longitude on the earth as positional information on the earth of the driver who carries the mobile device 91 on the basis of signals obtained from the satellite and outputs the detected information to the control unit 131.

The inertial sensor 134 is a generic term for sensors that detect information on an acceleration and posture (direction) of a driver carrying the mobile device 91, such as an acceleration sensor and a gyro sensor, which is controlled by the control unit 131, and outputs the detected information to the control unit 131. Moreover, the pieces of information on an acceleration and posture (direction) which are detected by the inertial sensor 134 will also be collectively referred to as inertial information.

The environment sensor 135 is a generic term for various sensors, such as a geomagnetic sensor, an atmospheric pressure sensor, and a carbon dioxide sensor, which are controlled by the control unit 131 and is a generic term for sensors that detect information such as the direction of a driver carrying the mobile device 91 with respect to terrestrial magnetism, atmospheric pressure around the driver, and the concentration of carbon dioxide. The environment sensor outputs the detected information to the control unit 131. Moreover, the information such as the direction with respect to terrestrial magnetism, atmospheric pressure, and the concentration of carbon dioxide detected by the environment sensor 135 will also be collectively referred to as environmental information.

The display unit 136, which is constituted by a liquid crystal display (LCD), an organic electro luminescence (EL), or the like, is controlled by the control unit 131 and displays a display image in which, for example, evaluation and comments for various driving acts generated in accordance with a discount of insurance premiums and a driving state generated by the server 72 are displayed. In addition, the display unit 136, which is constituted by a touch panel, functions as an operation unit, receives operation inputs from a driver, and outputs operation signals corresponding to operation contents of the received operation inputs to the control unit 131.

The control unit 131 controls the communication unit 132 to transmit positional information supplied from the GPS 133, inertial information supplied from the inertial sensor 134, and environmental information supplied from the environment sensor 135 to the server 72 as information of driving conditions. In addition, the control unit 131 controls the communication unit 132 to request a display image from the server 72 in response to an operation signal supplied by the operation of a touch panel of the display unit 136. Further, the control unit 131 controls the communication unit 132 to receive information of a display image generated by the server 72 on the basis of the information of driving conditions in response to the request, and causes the display unit 136 to display the display image.

(Configuration Example of Vehicle Control Unit 92)

The vehicle control unit 92, which is, for example, an engine control unit (ECU) or the like, controls various operations of the vehicle 73. The vehicle control unit including a control unit 151, a communication unit 152, a vehicle information detection unit 153, a vehicle interior image and sound detection unit 154, and a vehicle exterior image detection unit 155 detects vehicle information and transmits the detected information to the server 72.

The control unit 151, which is constituted by a processor, a memory, or the like, controls the overall operation of the vehicle control unit 92.

The communication unit 152 is controlled by the control unit 151, and transmits and receives data and programs to and from the server 72 or another communication apparatus through the network 71 such as a mobile phone public line, Bluetooth (registered trademark), or a wireless LAN.

The vehicle information detection unit 153 is a generic term for various sensors that detect, for example, a vehicle speed, a torque value, a steering wheel angle, a yaw angle (of the body of the vehicle 73), gear information, side brake information, a stepping amount of an accelerator pedal, a stepping amount of a brake pedal, blinker operation information, and lighting condition information of lights as various pieces of information regarding operations of the vehicle 73, and outputs the detected various pieces of detection information to the control unit 151. Moreover, the various pieces of detection information detected by the vehicle information detection unit 153 will also be collectively referred to as vehicle information.

The vehicle interior image and sound detection unit 154 is constituted by an image sensor such as a complementary metal oxide semiconductor (CMOS) or a charge coupled device (CCD) that images conditions of a driver inside the vehicle 73 and a microphone that records sounds inside the vehicle. The vehicle interior image and sound detection unit detects images and sounds inside the vehicle 73 and outputs the detected images and sounds to the control unit 151.

The vehicle exterior image detection unit 155, which is constituted by an image sensor such as a CMOS or a CCD which captures an image of the outside of the vehicle 73, outputs the captured image of the outside of the vehicle to the control unit 151.

Moreover, information on images and sounds detected by the vehicle interior image and sound detection unit 154 and information on images of the outside of the vehicle which are detected by the vehicle exterior image detection unit 155 will also be collectively referred to as vehicle inside and outside image information.

The control unit 151 controls the communication unit 152 to transmit vehicle inside and outside image information constituted by vehicle information detected by the vehicle information detection unit 153 and vehicle inside and outside image information detected by the vehicle interior image and sound detection unit 154 and the vehicle exterior image detection unit 155 to the server 72 through the network 71.

(Configuration Example of Biological Information Detection Unit 93)

The biological information detection unit 93 includes a control unit 171, a communication unit 172, and a biological sensor 173. For example, the biological information detection unit detects biological information of a driver and transmits the detected biological information to the server 72.

The control unit 171 is constituted by a processor, a memory, or the like and controls the overall operation of the biological information detection unit 93.

The communication unit 172 is controlled by the control unit 171, and transmits and receives data and programs to and from the server 72 or another communication apparatus through the network 71 such as a mobile phone public line, Bluetooth (registered trademark), or a wireless LAN.

The biological sensor 173 is a generic term for sensors that detect various pieces of information regarding a driver's living body. The biological sensor is, for example, a heartbeat sensor, a blood pressure sensor, an oxygen concentration sensor, a myoelectric sensor, a thermometer, a body tissue sensor, an alcohol sensor, a maximum oxygen intake sensor, a calorie consumption sensor, or the like, and outputs the detected biological information to the control unit 171.

Moreover, various detection results detected by the biological sensor 173 will also be collectively referred to as biological information.

<Configuration Example of Server>

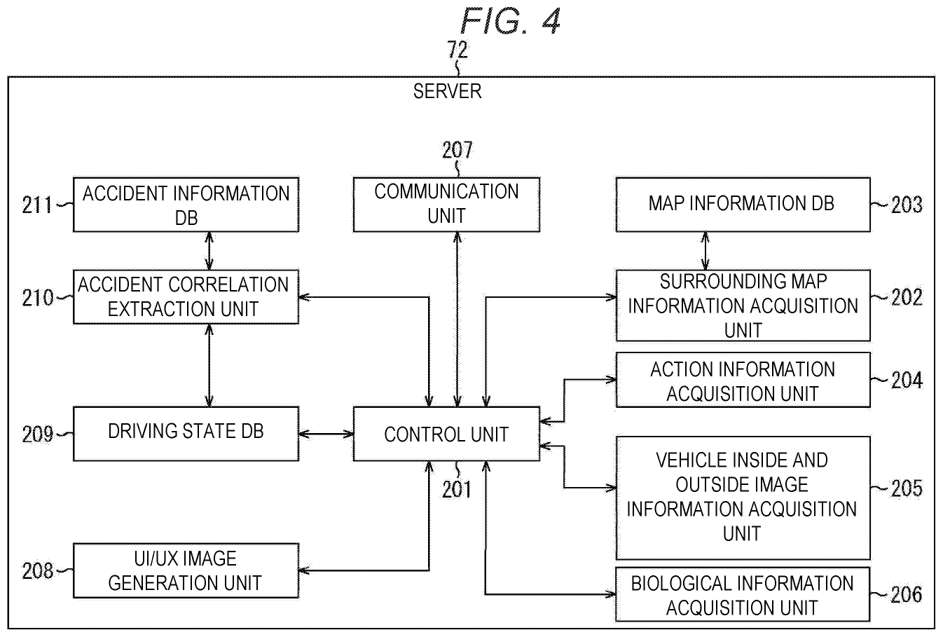

Next, a configuration example of the server 72 operated by an insurer will be described with reference to FIG. 4.

The server 72 includes a control unit 201, a surrounding map information acquisition unit 202, a map information database (DB) 203, an action information acquisition unit 204, a vehicle inside and outside image information acquisition unit 205, a biological information acquisition unit 206, a communication unit 207, a UI/UX image generation unit 208, a driving state database (DB) 209, an accident correlation extraction unit 210, and an accident information database (DB) 211.

The control unit 201 is constituted by a processor or a memory and controls the overall operation of the server 72. The control unit 201 controls the communication unit 207 to supply positional information supplied from the vehicle 73 to the surrounding map information acquisition unit 202 and the action information acquisition unit 204 and supply inertial information, environmental information, and vehicle information to the action information acquisition unit 204. In addition, the control unit 201 supplies vehicle inside and outside image information to the vehicle inside and outside image information acquisition unit 205 and supplies biological information to the biological information acquisition unit 206.

The surrounding map information acquisition unit 202 acquires positional information supplied from the mobile device 91, reads surrounding map information corresponding to positional information registered in the map information DB 203, and outputs the read surrounding map information to the control unit 201 as driving state information. The control unit 201 registers the driving state information constituted by the surrounding map information in the driving state DB 209 in association with information for identifying a driver and information on an acquisition time. In addition, the control unit 201 outputs positional information to the action information acquisition unit 204.

Here, in the map information DB 203, the surrounding map information registered in association with the positional information is information such as speed limits in a road on which a vehicle is traveling, the number of lanes, types of roads (automobile national highways, national roads only for automobiles, general national roads, prefectural roads, and the like), congestion information, temporary stop locations, intersections, crossings, tunnels, and Zone30 applicable roads (Zone30: a generic term for measures to secure safety for community roads that are defined as 30 km/h or less), points where accidents occur frequently, near-miss points (points where a driver is often observed to have an experience of being frightened or startled in case of danger while traveling), and the number of people passing by time slot, for example.

The action information acquisition unit 204 acquires positional information, inertial information, and environmental information supplied from the mobile device 91 and vehicle information supplied from the vehicle control unit 92 to generate action information based on these pieces of information as driving state information and outputs the generated action information to the control unit 201. The control unit 201 registers driving state information constituted by action information in the driving state DB 209 in association with information for identifying drivers and information of an acquisition time.

Here, the action information is information generated on the basis of inertial information, environmental information, vehicle information, and vehicle inside and outside image information. The action information includes, for example, a vehicle speed, an acceleration, a horizontal direction acceleration, a steering wheel angle, a yaw angle, an engine speed, a torque value, a side brake operation flag, a light operation flag, a gear operation flag, an accelerator operation flag, a brake operation flag, a blinker operation flag, a lane change action, back action, vehicle inside and outside atmospheric pressures, vehicle inside and outside carbon dioxide concentrations, a latitude and a longitude obtained by a GPS, operation information of the mobile device 91, and the like.

The vehicle inside and outside image information acquisition unit 205 acquires vehicle inside and outside image information supplied from the vehicle control unit 92 and outputs the vehicle inside and outside image information to the control unit 201 as driving state information. The control unit 201 registers driving state information constituted by vehicle inside and outside image information in the, driving state DB 209 in association with information for identifying a driver and information on an acquisition time.

The biological information acquisition unit 206 generates driving state information on the basis of biological information supplied from the biological information detection unit 93 and outputs the generated information to the control unit 201. The control unit 201 registers driving state information based on biological information in the driving state DB 209 in association with information for identifying a driver and information on an acquisition time.

Here, the driving state information based on the biological information includes, for example, a body temperature, a pulse, a blood pressure, an oxygen concentration in the blood, the degree of blood sugar, the degree of muscle contraction, an alcohol concentration, a consumed calorie, the degree of fatigue, the degree of concentration, stress, and a sleeping time.

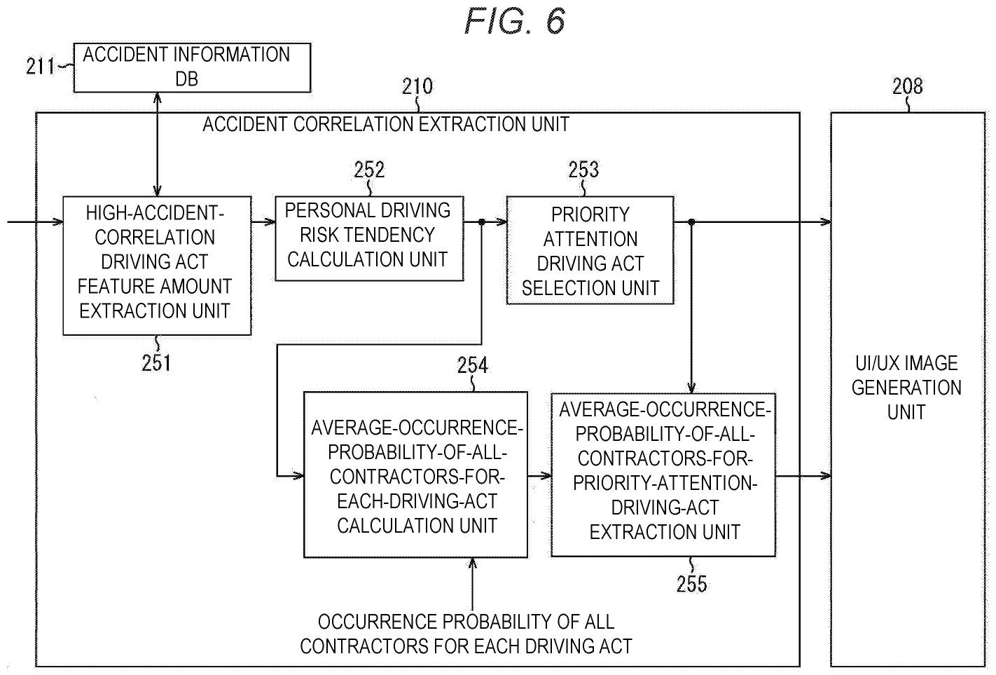

The accident correlation extraction unit 210 collates various pieces of driving state information registered in the driving state DB 209 with accident information registered in the accident information DB 211, and calculates a degree of risk on the basis of an occurrence probability and a degree of contribution of a driver in a driving act (action) with a high accident correlation. In addition, the accident correlation extraction unit 210 extracts a priority attention driving act of which the degree of risk is higher, calculates an occurrence probability of the priority attention driving act of the driver, a degree of contribution, a degree of risk, and an average occurrence probability of all contractors and outputs those pieces of information to the control unit 201. Moreover, a detailed configuration of the accident correlation extraction unit 210 will be described later with reference to FIG. 6.

The control unit 201 supplies information including the supplied occurrence probability of the priority attention driving act of the driver, degree of contribution, degree of risk, and average occurrence probability of all contractors to the UI/UX image generation unit 208.

The UI/UX image generation unit 208 generates a corresponding UI/UX image on the basis of the information including the occurrence probability of the priority attention driving act of the driver, the degree of contribution, the degree of risk, and an average occurrence probability of all contractors and supplies the generated UI/UX image to the control unit 201.

The control unit 201 controls the communication unit 207 so as to transmit the UI/UX image generated on the basis of the information including the occurrence probability of the priority attention driving act of the driver, the degree of contribution, the degree of risk, and an average occurrence probability of all contractors, which are supplied from the UI/UX image generation unit 208, to the mobile device 91.

The control unit 131 of the mobile device 91 controls the communication unit 132 so as to receive the UI/UX image generated on the basis of the information including the occurrence probability of the priority attention driving act of the driver, the degree of contribution, the degree of risk, and an average occurrence probability of all contractors and transmitted from the server 72 and display the received UI/UX image on the display unit 136.

<Flow of Data>

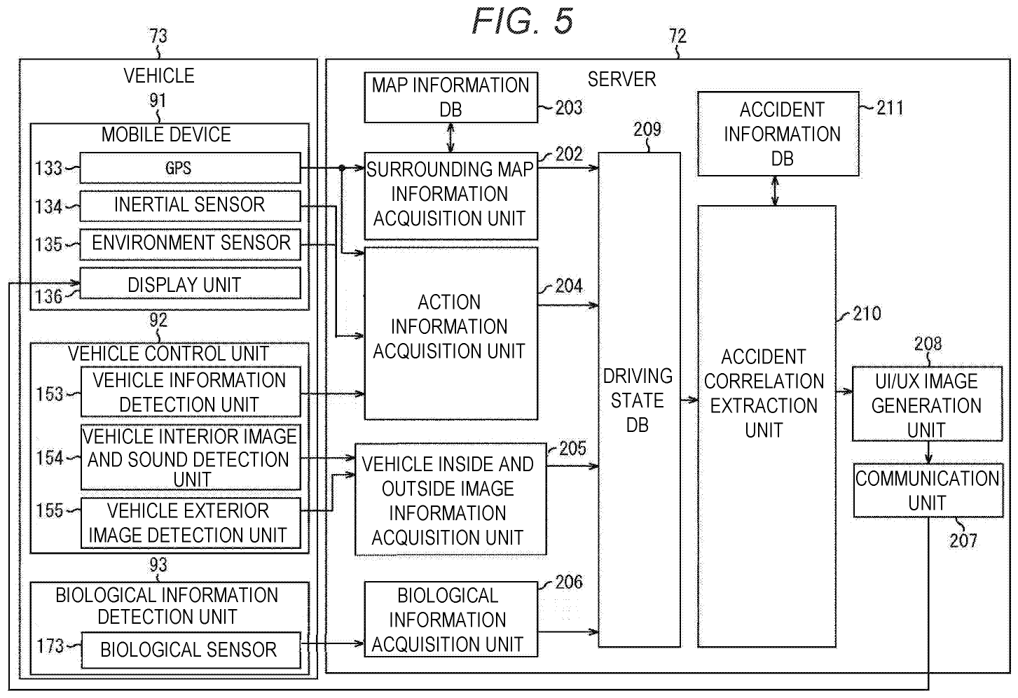

Next, flows of data in the server 72 and the vehicle 73 will be described with reference to FIG. 5. That is, flows of data in the server 72 and the vehicle 73 described above have a relationship as shown in FIG. 5 in brief.

Positional information constituted by a latitude and a longitude on the earth based on signals obtained from a satellite not shown in the drawing and generated by the GPS 133 of the mobile device 91 is supplied to the surrounding map information acquisition unit 202.

The surrounding map information acquisition unit 202 accesses the map information DB 203, reads corresponding map information on the basis of positional information, and registers the read information in the driving state DB 209 as driving state information in association with information for identifying a driver and information on an acquisition time.

The positional information constituted by a latitude and a longitude on the earth based on signals obtained from a satellite not shown in the drawing and generated by the GPS 133, inertial information detected by the inertial sensor 134, environmental information detected by the environment sensor 135, and vehicle information detected by the vehicle information detection unit 153 of the vehicle control unit 92 are supplied to the action information acquisition unit 204.

The action information acquisition unit 204 generates action information on the basis of positional information, inertial information, and environmental information, and vehicle information and registers the generated information in the driving state DB 209 as driving state information in association with information for identifying a driver and information on an acquisition time.

Vehicle interior image information detected by the vehicle interior image and sound detection unit 154 of the vehicle control unit 92 and vehicle inside and outside image information constituted by a vehicle exterior image detected by the vehicle exterior image detection unit 155 are supplied to the vehicle inside and outside image information acquisition unit 205.

The vehicle inside and outside image information acquisition unit 205 registers the vehicle inside and outside image information in the driving state DB 209 as driving state information in association with information for identifying a driver and information on an acquisition time.

Biological information detected by the biological sensor 173 of the biological information detection unit 93 is supplied to the biological information acquisition unit 206.

The biological information acquisition unit 206 registers biological information in the driving state DB 209 as driving state information in association with information for identifying a driver and information on an acquisition time.

That is, map information, action information, vehicle inside and outside image information, and biological information are registered in the driving state DB 209 in association with information for identifying a driver and an acquisition time. Moreover, driving state information registered in the driving state DB 209 is identified and registered for each of a plurality of drivers who are all contractors.

The accident correlation extraction unit 210 extracts a driving act which is highly correlated to an accident among driving acts of a driver which are classified on the basis of at least any one of the map information, the action information, the vehicle inside and outside image information, or the biological information registered in the accident information DB 211 in association with accidents, and calculates a degree of risk from an occurrence probability of the extracted driving act and a degree of contribution of the driving act.

In addition, the accident correlation extraction unit 210 obtains a higher-rank driving act as a priority attention driving act among the degrees of risk of driving acts which are highly correlated to an accident of a driver, and outputs information on an occurrence probability, a degree of contribution, and a degree of risk of the priority attention driving act to the UI/UX image generation unit 208.

In addition, the accident correlation extraction unit 210 obtains an average occurrence probability of a driving act which is highly correlated to individual accidents of all contractors and outputs an average occurrence probability of a priority attention driving act among these to the UI/UX image generation unit 208.

Moreover, a configuration of the accident correlation extraction unit 210 will be described later in detail with reference to FIG. 6.

The UI/UX image generation unit 208 calculates whether or not insurance premiums will be discounted on the basis of information on an occurrence probability, a degree of contribution, and a degree of risk of a driving act which is highly correlated to an accident, among priority attention driving acts of a driver. In addition, the UI/UX image generation unit 208 generates a UI/UX image using all or some of pieces of information on the occurrence probability, the degree of contribution, and the degree of risk of a priority attention driving act for a driver, and information on an average occurrence probability of priority attention driving acts of all contractors and a discount of insurance premiums. In addition, the UI/UX image generation unit 208 transmits the generated UI/UX image to the mobile device 91. The mobile device 91 displays the UI/UX image transmitted from the UI/UX image generation unit 208 on the display unit 136.

So-called driving characteristic reflected (pay how you drive (PHYD)) automobile driving insurance using telematics and having the technique of the present disclosure applied thereto is realized by a configuration of the information processing system 51 constituted by the network 71 to the vehicle 73 shown in FIGS. 2 to 5.

<Configuration Example of Accident Correlation Extraction Unit>

Next, a configuration example of the accident correlation extraction unit 210 will be described with reference to FIG. 6.

The accident correlation extraction unit 210 includes a high-accident-correlation driving act feature amount extraction unit 251, a personal driving risk tendency calculation unit 252, a priority attention driving act selection unit 253, an average-occurrence-probability-of-all-contractors-for-each-driving-act calculation unit 254, and an average-occurrence-probability-of-all-contractors-for-priority-attention-driving-act extraction unit 255.

The high-accident-correlation driving act feature amount extraction unit 251 extracts a driving act which is highly correlated to an accident as a feature amount on the basis of driving state information of a driver who requests a UI/UX image constituted by an evaluation image among pieces of driving state information registered in the driving state DB 210. In addition, the high-accident-correlation driving act feature amount extraction unit 251 outputs the feature amount to the personal driving risk tendency calculation unit 252 in association with information for identifying a driver and an acquisition time.

Here, the driving act which is highly correlated to an accident is, for example, a driving act for which it is regarded that a difference between the occurrence probability for a contractor having caused an accident and a contractor having not caused an accident, among all insurance contractors, is larger than a predetermined value, that is, a driving act regarded as being highly correlated to an accident, the difference being obtained by comparing the two probabilities with each other for each of driving states obtained from the pieces of driving state information registered in the driving state DB 209.

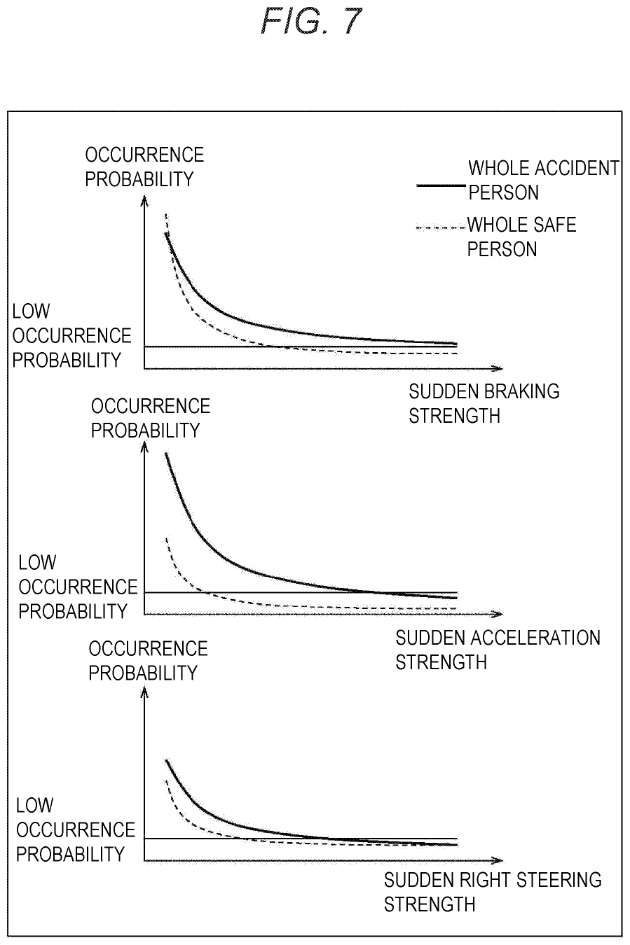

For example, as shown in an upper stage, a middle stage, and a lower stage of FIG. 7, it is considered that the occurrence probabilities of sudden braking, sudden acceleration, and right sudden steering, among driving acts specified from driving state information, are compared with each other using data of an accident person who is a driver having caused an accident and data of a safe person having not caused an accident.

Moreover, in the upper stage of FIG. 7, a horizontal axis represents a sudden braking strength, and a vertical axis represents an occurrence probability. Further, in the middle stage of FIG. 7, a horizontal axis represents a sudden acceleration strength, and a vertical axis represents an occurrence probability. Further, in the lower stage of FIG. 7, a horizontal axis represents a sudden right steering strength, and a vertical axis represents an occurrence probability. In addition, a region regarded as a low occurrence probability among the occurrence probabilities is shown by a range below a dashed line.

In this manner, for all of the three types of driving acts of sudden braking, sudden acceleration, and right sudden steering, there is a range of a strength in which there is a significant difference between an accident person and a safe person, that is, a range of a strength which is highly correlated to an accident.

That is, in a range around the middle of a sudden braking strength in the sudden braking as shown in the upper stage of FIG. 7, a range in which it is regarded that a strength has a minimum value and an occurrence probability is a low occurrence probability in sudden acceleration as shown in the middle stage of FIG. 7, and a range in which it is regarded that a strength has a minimum value and an occurrence probability is a low occurrence probability in a sudden right steering as shown in the lower stage of FIG. 7, it is regarded that there is a distinct difference between an accident person and a safe person, in other words, it is regarded that the ranges are highly correlated to an accident.

Consequently, the high-accident-correlation driving act feature amount extraction unit 251 stores this driving act, that is, a driving act in a range in which there is a large difference between the occurrence probability of an accident person and the occurrence probability of a safe person, among sudden braking, sudden acceleration, and right sudden steering, and which is a driving act highly correlated to an accident, particularly as shown in FIG. 7, as an accident correlation model, and extracts a driving act equivalent to the accident correlation model as a feature amount.

Among driving acts regarded as sudden braking, a driving act having a strength range from a predetermined minimum value to a maximum value is extracted as a driving act which is highly correlated to an accident. This is the same as for sudden acceleration and right sudden steering.

In addition, driving acts may include, for example, driving acts which are highly correlated to an accident and obtained by a combination of sudden left steering, unsteady driving, inattentive driving, a sleeping time of 6 hours or less or the like on the previous day, map information, action information, vehicle inside and outside image information, biological information, and the like, in addition to sudden braking, sudden acceleration, and right sudden steering.

In addition, a driving act may be sudden braking, for example, at a predetermined intersection which is combined with positional information, sudden acceleration, for example, when an operation of turning on a blinker which is combined with a predetermined another operation, or the like.

In this manner, the high-accident-correlation driving act feature amount extraction unit 251 may store a driving act which is highly correlated to an accident as an accident correlation model in advance and may extract a driving act corresponding to the accident correlation model as a feature amount on the basis of driving state information registered in the driving state DB 208.

Moreover, these accident correlation models may be obtained by, for example, linear regression analysis or multiple regression analysis based on negative binomial distribution, lognormal distribution, or the like with respect to driving state information registered in the driving state DB 209. In addition, these accident correlation models may be obtained by a Bayesian network, a decision tree, a support vector machine, a neural network, or the like. In addition, hereinafter, a driving act which is highly correlated to an accident and stored as an accident correlation model will be referred to as a high-accident-correlation driving act.

Further, in generating an accident correlation model, an example in which driving acts are divided into a driving act of an accident person and a driving act of a safe person on the basis of a concept of an accident, and a driving act having a difference in the occurrence probability therebetween is larger than a predetermined value is classified as a high-accident-correlation driving act has been described above. However, in generating an accident correlation model, the accident correlation model may be generated on the basis of something other than an occurrence probability in driving acts of an accident person and a safe person.

For example, instead of simply performing division according to a concept regarding whether or not an accident has occurred, an accident correlation model may be generated by classifying accidents into categories of a vehicle-to-person accident, a damage only accident, a vehicular accident, and a personal accident and performing division into an accident person and a safe person in each of the categories. In this manner, it is possible to set a discount rate of insurance premiums for each of the categories such as the vehicle-to-person accident, the damage only accident, the vehicular accident, and the personal accident. Categories of accidents may be categories other than the above-described four types of a vehicle-to-person accident, a damage only accident, a vehicular accident, and a personal accident. For example, categories may be set by combining situations such as ages or sexes of drivers and the types of vehicles including an automobile, a truck, and a motorcycle.

The personal driving risk tendency calculation unit 252 may calculate a personal driving risk tendency for each driver on the basis of information of a high-accident-correlation driving act which is extracted by the high-accident-correlation driving act feature amount extraction unit 251.

Here, the driving risk tendency includes an occurrence probability, a degree of contribution, and a degree of risk of each of high-accident-correlation driving acts of an individual driver.

Here, the degree of contribution which is set for a high-accident-correlation driving act indicates the degree of correlation to the occurrence of an accident, and for example, can be obtained by performing regression analysis on a driving act extracted as a high-accident-correlation driving act of an individual driver. In other words, regarding the degree of contribution of a predetermined driving act, a possibility of causing an accident (contributing to the occurrence of an accident) increases as the degree of contribution becomes higher.

The personal driving risk tendency calculation unit 252 calculates a degree of risk on the basis of a degree of contribution and an occurrence probability for each high-accident-correlation driving act. A degree of risk is obtained by, for example, a product of a degree of contribution and an occurrence probability. In addition, the personal driving risk tendency calculation unit 252 outputs information on the occurrence probability, the degree of contribution, and the degree of risk for each driving act which is highly correlated to an accident to the priority attention driving act selection unit 253.

For example, it is assumed that an occurrence probability for each high-accident-correlation driving act i (i=0, 1, 2, 3, . . . ) is expressed by an occurrence probability xi (i=0, 1, 2, 3, . . . ), a degree of contribution is expressed by a degree of contribution wi (i=0, 1, 2, 3, . . . ), and a degree of risk is expressed by a degree of risk pi. Here, it is assumed that the personal driving risk tendency calculation unit 252 calculates, for example, a degree of risk pi (=F(xi,wi)) by an occurrence probability xi×100×a degree of contribution wi×10.

Here, it is assumed that driving acts i which are highly correlated to an accident (i=0 to 5) are sudden acceleration, sudden braking, sudden right steering, sudden left steering, unsteady driving, and inattentive driving.

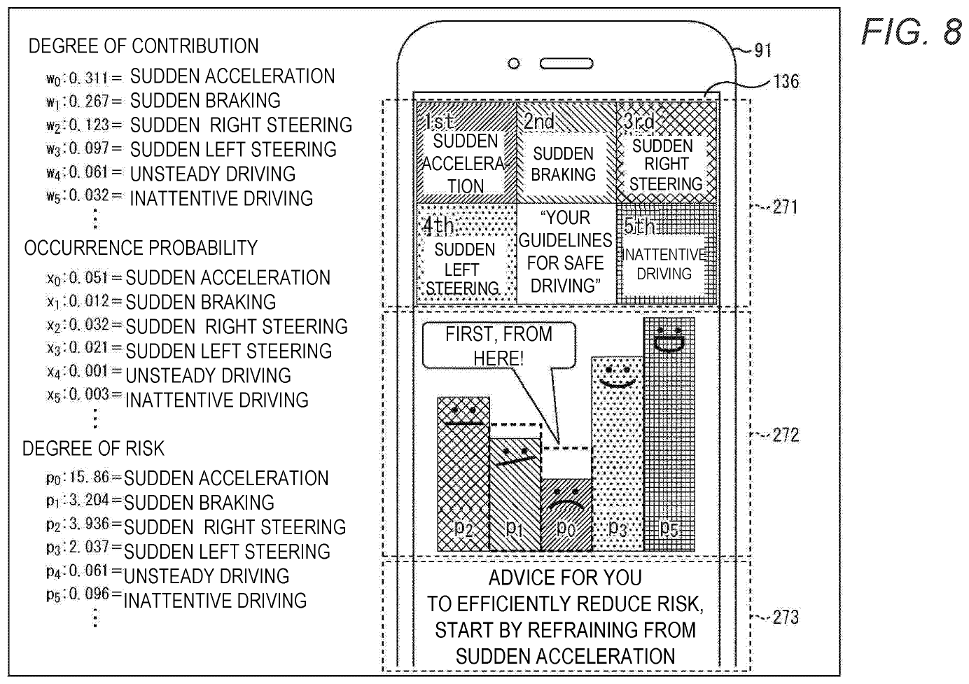

In this case, as shown in a left portion of FIG. 8, it is assumed that a degree of contribution w0 of sudden acceleration in a case of a driving act i=0 is 0.311, an occurrence probability x0 thereof is 0.051, a degree of contribution w1 of sudden braking in a case of a driving act i=1 is 0.267, and an occurrence probability x1 thereof is 0.012. In addition, it is assumed that a degree of contribution w2 of sudden right steering in a case of a driving act i=2 is 0.123, an occurrence probability x2 thereof is 0.032, a degree of contribution w3 of sudden left steering in a case of a driving act i=3 is 0.097, and an occurrence probability x3 thereof is 0.021. Further, it is assumed that a degree of contribution w4 of unsteady driving in a case of a driving act i=4 is 0.061, an occurrence probability x4 thereof is 0.001, a degree of contribution w5 of sudden right steering in a case of a driving act i=5 is 0.032, and an occurrence probability x2 thereof is 0.003.

In this case, when high-accident-correlation driving acts i (i=0 to 5) are sudden acceleration, sudden braking, sudden right steering, sudden left steering, unsteady driving, and inattentive driving, the degrees of risk thereof are a degree of risk p0=15.86 (=F(x0,w0)=0.311×100×0.051×10), a degree of risk p1=3.204 (=F(x1,w1)=0.267×100×0.012×10), a degree of risk p2=3.936 (=F(x2,w2)=0.123×100×0.032×10), a degree of risk p3=2.037 (=F(x3,w3)=0.097×100×0.021×10), a degree of risk p4=0.061 (=F(x4,w4)=0.061×100×0.001×10), a degree of risk p5=0.096 (=F(x5,w5)=0.032×100×0.003×10).

The priority attention driving act selection unit 253 selects a high-accident-correlation driving act of which the risk degree is higher by a predetermined number as a priority attention driving act on the basis of information on a personal driving risk tendency supplied from the personal driving risk tendency calculation unit 252, and outputs the selected high-accident-correlation driving act to the UI/UX image generation unit 208. In addition, the priority attention driving act selection unit 253 outputs information of the selected priority attention driving act to the average-occurrence-probability-of-all-contractors-for-priority-attention-driving-act extraction unit 255.

The average-occurrence-probability-of-all-contractors-for-each-driving-act calculation unit 254 obtains an average value of individual driving risk tendencies of all contractors and outputs the obtained average value to the average-occurrence-probability-of-all-contractors-for-priority-attention-driving-act extraction unit 255. Here, the driving risk tendency calculated by the personal driving risk tendency calculation unit 252 is an individual driving risk tendency of an individual driver. For this reason, information on the occurrence probabilities of high-accident-correlation driving acts which are calculation results obtained from the other personal driving risk tendency calculation units 252 that calculates driving risk tendencies of all contractors is supplied to the average-occurrence-probability-of-all-contractors-for-each-driving-act calculation unit 254. Thereby, the average-occurrence-probability-of-all-contractors-for-each-driving-act calculation unit 254 calculates an average value of the occurrence probabilities of all high-accident-correlation driving acts of all contractors and outputs the calculated average value to the average-occurrence-probability-of-all-contractors-for-priority-attention-driving-act extraction unit 255.

The average-occurrence-probability-of-all-contractors-for-priority-attention-driving-act extraction unit 255 extracts an average occurrence probability of all contractors corresponding to the above-described priority attention driving act selected on the basis of the driving risk tendency of the driver and outputs the extracted average occurrence probability to the UI/UX image generation unit 208.

The UI/UX image generation unit 208 generates a UI/UX image from information on a personal driving risk tendency for a priority attention driving act of which the degree of risk is higher by a predetermined number and information on an average occurrence probability of all contractors corresponding to the priority attention driving act, and transmits the generated UI/UX image to the mobile device 91.

In addition, the UI/UX image generation unit 208 obtains a discount of insurance premiums (for example, a discount rate, Cash Back, a Cash Back rate) on the basis of the degree of risk in a priority attention driving act.

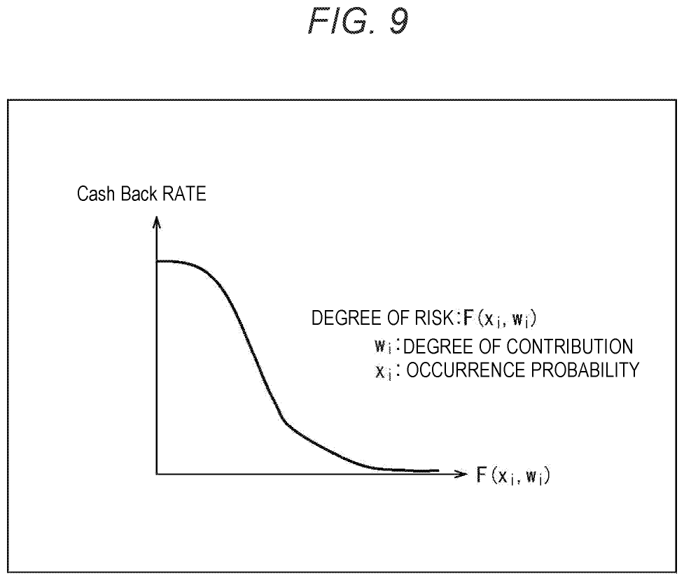

The UI/UX image generation unit 208 calculates a discount of insurance premiums (Cash Back) in accordance with, for example, degrees of risk pi (=F(xi,wi)). The discount of insurance premiums is obtained on the basis of the degree of risk of a priority attention driving act, and is obtained using, for example, a function indicating a discount rate for the degree of risk as shown in FIG. 9, with respect to a degree of risk for each priority attention driving act.

In FIG. 9, a horizontal axis represents a degree of risk F(xi,wi) (=pi), and a vertical axis represents a discount of insurance premiums (Cash Back) (discount rate). That is, a discount rate of insurance premiums becomes higher as a degree of risk F(xi,wi) decreases, and a discount rate of insurance premiums becomes lower as a degree of risk increases. In addition, a discount rate to be applied is set as a discount rate of insurance premiums of a driver, for example, in all priority attention driving acts of the predetermined driver using functions as shown in FIG. 9. That is, in a case where there are three types of driving acts of priority attention acts of “sudden acceleration”, “sudden braking”, and “sudden steering” and discount rates based on the degrees of risk thereof are 10%, 15%, and 12%, respectively, a discount rate of insurance premiums of a driver is set as 10% to be applied to all of the three types of driving acts.

The UI/UX image generation unit 208 generates a UI/UX display image constituted by a driving risk tendency for a priority attention driving act of an individual driver and an evaluation image for a priority attention driving act based on information of a discount rate.

More specifically, in a case where driving acts which are highly correlated to an accident up to the top five, among the degrees of risk shown in the lower left portion of FIG. 8, are set to be priority attention driving acts, information on a driving risk tendency of an individual driver having sudden acceleration of i=0, sudden braking of i=1, sudden right steering of i=2, sudden left steering of i=3, and inattentive driving of i=4 with respect to a driving act i and information on an average value of driving risk tendencies of all contractors are supplied to the UI/UX image generation unit 208.

The UI/UX image generation unit 208 generates, for example, a UI/UX image which is an evaluation image for evaluating driving of a driver as shown in the right portion of FIG. 8 and displays the generated UI/UX image on the display unit 136 of the mobile device 91.

A display column 271 in which driving acts to be noted are displayed is displayed in the upper portion of the UI/UX image which is the evaluation image for evaluating driving of the driver as shown in the right portion of FIG. 8. In addition, a display column 272 in which the degrees of risk of priority attention driving acts are displayed as bar graphs is provided below the display column 271. Further, a display column 273 in which a comment for a driving risk tendency of the driver is displayed is provided below the display column 272.

In the display column 271 shown in the right portion of FIG. 8, “guidelines for your safe driving” is displayed in the lower center, and guidelines for a driver's safe driving are displayed as an evaluation image. In addition, “1th” to “5th” are displayed from the left to the right at the upper stage and in the left and right portions at the lower stage, and the top first to fifth ranks of priority attention driving acts are displayed.

In the display column 271 of FIG. 8, a driving act of a first rank of the priority attention driving acts is “sudden acceleration”, a driving act of a second rank is “sudden braking”, a driving act of a third rank is “sudden right steering”, a driving act of a fourth rank is “sudden steering”, and a driving act of a fifth rank is “unsteady driving”. That is, driving acts which are highly correlated to an accident up to the top five, among the degrees of risk shown in the lower left portion of FIG. 8, are displayed as shown as priority attention driving acts.

For this reason, driving acts that should be particularly preferentially noted, among driving acts which are highly correlated to an accident, are clearly displayed, a driver himself or herself can appropriately recognize what should be preferentially noted in safe driving.

Further, in the display column 272, for example, values constituted by the reciprocals of the degrees of risk p0 to p3 and p5 for a driving act having a high degree of risk in a personal driving risk tendency of each of “sudden acceleration”, “sudden braking”, “sudden right steering”, “sudden steering”, and “unsteady driving” from the left are displayed as bar graphs.

For this reason, the driver can recognize how a priority attention driving act is evaluated during his or her driving. In addition, since a bar graph is displayed as the reciprocal of an actual degree of risk, a value having a high degree of risk is expressed small, and a value having a low degree of risk is expressed large, so that a point having a low degree of risk is highly evaluated and displayed as if it is praised. Therefore, since a weak part having a high degree of risk is not expressed in an emphasized manner, display is performed so that the driver can easily receive evaluation for his or her own driving risk tendency.

Further, a target degree graph indicating a target level required to receive a discount of insurance premiums is shown as a dashed line for the bar graphs of “sudden acceleration” and “sudden braking” in the display column 272.

In FIG. 8, in a case where a discount of insurance premiums is received, a target degree graph shown as a dashed line is not displayed.

The target degree graph is shown as, for example, a target value of the reciprocal of a degree of risk for achieving a predetermined discount rate of insurance premiums, and is set such that a discount of insurance premiums is obtained when the reciprocal of a degree of risk becomes larger than the target degree graph. Thereby, the driver can recognize how much the driver further pays attention for improving evaluation for the reciprocal of the degree of risk of “sudden acceleration” or “sudden braking” in order to obtain a discount of insurance premiums.

Further, in the display column 273, “to efficiently reduce risk, start by refraining from sudden acceleration,” is displayed. This makes it possible to prompt the driver to know what should be noted during driving in order to reduce risk and to present to the driver what should be performed in order to discount insurance premiums. Correspondingly, in the display column 282, a call display for making it easy to recognize a driving act to be noted, such as “first, from here!” is performed for the graph of “sudden acceleration”.

Moreover, the UI/UX image generation unit 208 may use, for example, an average occurrence probability of all contractors for a priority attention driving act, in addition to a driving risk tendency and a discount rate for a priority attention driving act of an individual driver in generating a UI/UX image. More specifically, a UI/UX image in which an occurrence probability of a priority attention driving act of an individual driver is compared with an average occurrence probability of all contractors for a priority attention driving act is generated and displayed, so that the superiority or inferiority of an occurrence probability of the driver for an average occurrence probability of all contractors may be presented. Further, for example, in a case where a driver is significantly inferior to the other contractors with respect to a specific driving act through comparison between all of the contractors, a display image of “You need to pay attention to the driving act because you are significantly inferior to an average of all of the contractors.” is generated and displayed, and thus it is possible to clearly present objective facts, and more specifically improve consciousness of safe driving after recognizing a driving act to be noted.

In addition, when evaluation relative to other contractors is used for a discount rate of insurance premiums, a case in which an accident is caused is extremely rare. Therefore, there is a concern that a discount rate of insurance premiums of an insurant who has caused an accident is set to be extremely small with respect to a discount rate of insurance premiums of an insurant who has not caused an accident.

However, according to the above-described method, it is possible to evaluate a discount of insurance premiums in accordance with a driving act of an individual driver, irrespective of whether or not an accident occurred in the past. That is, a discount rate of insurance premiums is set regardless of whether or not a driver caused an accident in the past, so that it is possible to prevent a driver who has caused an accident even once from being evaluated as having a low discount rate. For this reason, it is possible to improve consciousness of safe driving using an incentive such as a discount of insurance premiums even for a driver who caused an accident in the past. However, in setting a discount rate of insurance premiums, relative evaluation may be used as necessary.

<Driving State DB Generation Process>

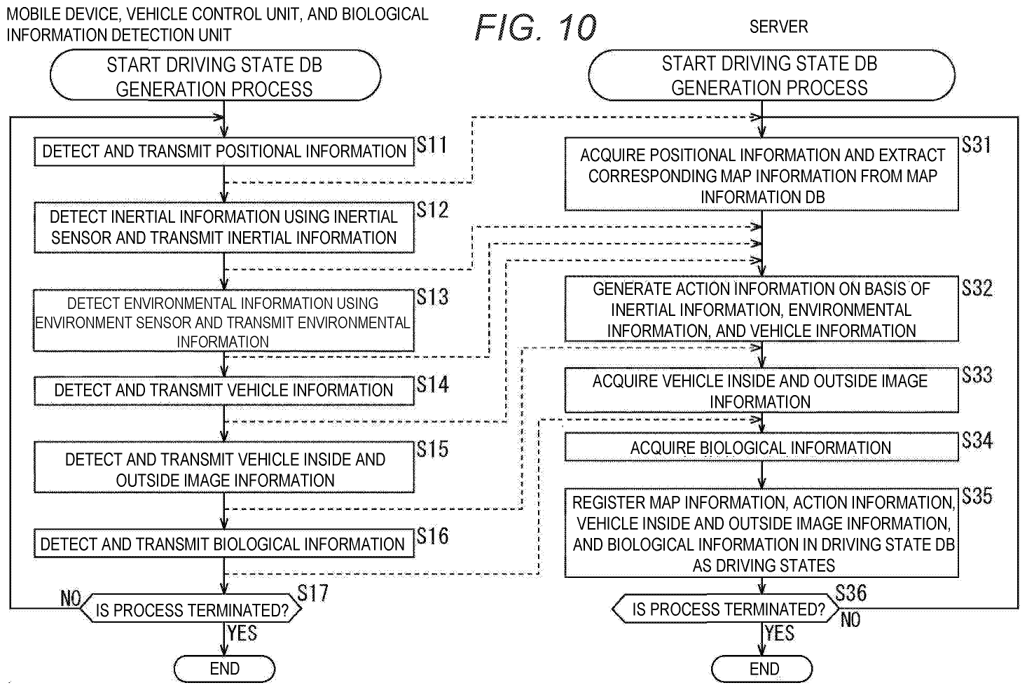

Next, a driving state DB generation process will be described with reference to a flowchart of FIG. 10.

In step S11, positional information constituted by a latitude and a longitude on the earth is transmitted to the surrounding map information acquisition unit 202 and the action information acquisition unit 204 of the server 72 on the basis of signals obtained from a satellite not shown in the drawing by the GPS 133 of the mobile device 91.

In step S31, the surrounding map information acquisition unit 202 of the server 72 accesses the map information DB 203 and extracts corresponding map information on the basis of the positional information.

In step S12, positional information constituted by a latitude and a longitude on the earth is transmitted to the action information acquisition unit 204 of the server 72 based on signals obtained from a satellite not shown and generated by the GPS 133 of the mobile device 91.

In step S13, inertial information detected by the inertial sensor 134 is transmitted to the action information acquisition unit 204 of the server 72.

In step S14, environment information detected by the environment sensor 135 is transmitted to the action information acquisition unit 204 of the server 72.

In step S32, action information is detected by the action information acquisition unit 204 of the server 72 on the basis of the positional information, the inertial information, and the environmental information.

In step S15, vehicle inside and outside image information detected by the vehicle interior image and sound detection unit 154 and vehicle inside and outside image information constituted by a vehicle exterior image information detected by the vehicle exterior image detection unit 155 are transmitted to the vehicle inside and outside image information acquisition unit 205.

In step S33, vehicle inside and outside image information is acquired by the vehicle inside and outside image information acquisition unit 205.

In step S16, biological information detected by the biological sensor 173 is transmitted to the biological information acquisition unit 206 of the server 72.

In step S34, the biological information is acquired by the biological information acquisition unit 206.

In step S35, the surrounding map information acquisition unit 202, the action information acquisition unit 204, the vehicle inside and outside image information acquisition unit, and the biological information acquisition unit 206 respectively register the map information, the action information, the vehicle inside and outside image information, and the biological information in the driving state DB 209 as driving state information in association with information for identifying a driver and information on an acquisition time.

In steps S17 and S36, it is determined whether or not the process is terminated. In a case where an instruction of termination has not been given, the process returns to steps S11 and S31, and the process of steps S11 and S31 and subsequent steps is repeated. Further, in steps S17 and S36, when an instruction for termination has been given, the process is terminated.

According to the above-described process, the map information, the action information, the vehicle inside and outside image information, and the biological information are registered in the driving state DB 209 as driving state information in association with information for identifying a driver and information on an acquisition time.

<UI/UX Image Display Process>

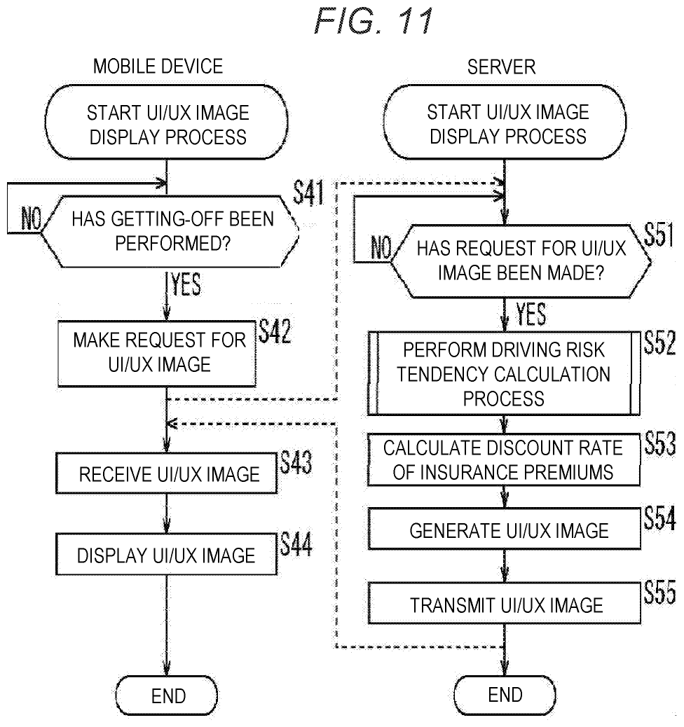

Next, a UI/UX image display process for displaying, for example, a UI/UX image as shown in FIG. 8 on the basis of driving state information registered in the driving state DB 209 will be described with reference to a flowchart of FIG. 11.

In step S41, the control unit 131 determines whether or not a driver who is the owner of the mobile device 91 has got off the vehicle 73, for example, from the vibration of an engine, a change in a moving speed, or the like on the basis of detection results obtained by the inertial sensor 134. In step S41, the control unit 131 repeats the same process until getting-off is detected. In step S41, in a case where getting-off is detected, the process proceeds to step S42.

In step S42, the control unit 131 controls the communication unit 132 so as to request a UI/UX image constituted by an evaluation image from the server 72. In this case, the control unit 131 makes a request for the UI/UX image constituted by the evaluation image and transmits information for identifying the driver who is the owner of the mobile device 91 to the server 72 together.

In step S51, the control unit 201 controls the communication unit 207 so as to determine whether or not a request for the UI/UX image constituted by the evaluation image has been made, and repeats the same process until the request is made. Further, in step S51, in a case where a request for the UI/UX image constituted by the evaluation image has been made, the process proceeds to step S52.

In step S52, the control unit 201 causes the accident correlation extraction unit 210 to execute a driving risk tendency calculation process.

A driving risk tendency of a priority attention driving act of the driver of the vehicle 73 who is the owner of the mobile device 91 and occurrence probabilities of all contractors with respect to the priority attention driving act of the driver are calculated through the driving risk tendency calculation process on the basis of the driving state information registered in the driving state DB 209.

Here, the driving risk tendency is constituted by an occurrence probability, a degree of contribution, and a degree of risk which correspond to the priority attention driving act of the driver.

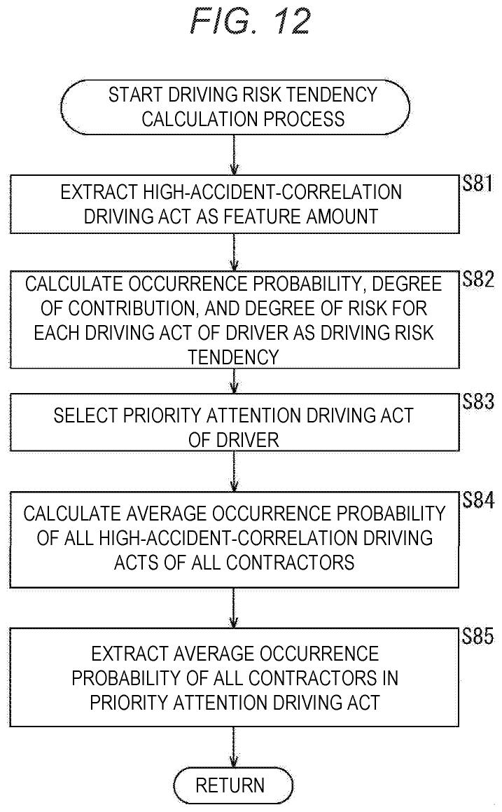

Moreover, the driving risk tendency calculation process will be described later in detail with reference to FIG. 12.

In step S53, the control unit 201 supplies the calculated driving risk tendency including an occurrence probability, a degree of contribution, and a degree of risk corresponding to the priority attention driving act of the driver and information on probabilities of occurrence of all contractors with respect to the priority attention driving act of the driver to the UI/UX image generation unit 208.

The UI/UX image generation unit 208 calculates a discount rate of insurance premiums on the basis of a degree of risk corresponding to the priority attention driving act of the driver which is calculated by the accident correlation extraction unit 210.

That is, the UI/UX image generation unit 208 calculates a discount rate of insurance premiums using, for example, the function indicating a relationship between a degree of risk and a discount rate of insurance premiums which is described with reference to FIG. 9, on the basis of a degree of risk corresponding to the priority attention driving act of the driver.

In step S54, the UI/UX image generation unit 208 generates a UI/UX image on the basis of the driving risk tendency including the occurrence probability, the degree of contribution, and the degree of risk corresponding to the priority attention driving act of the driver and outputs the generated UI/UX image to the control unit 201. Here, the generated UI/UX image is, for example, the evaluation image for evaluating the driving of the driver which is described with reference to FIG. 8.

In step S55, the control unit 201 controls the communication unit 207 so as to transmit the UI/UX image generated by the UI/UX image generation unit 208 to the mobile device 91.

In step S42, the control unit 131 of the mobile device 91 causes the communication unit 132 to receive the UI/UX image transmitted from the server 72.

In step S43, the control unit 131 displays the UI/UX image received by the communication unit 132 on the display unit 136.

According to the above-described process, a driving risk tendency for each driver is obtained on the basis of driving state information of the driver which is registered in the driving state DB 210. A discount rate of insurance premiums is calculated on the basis of information of the driving risk tendency, and a UI/UX image is generated and displayed.

<Driving Risk Tendency Calculation Process>

Next, a driving risk tendency calculation process will be described with reference to a flowchart of FIG. 12.

In step S81, the high-accident-correlation driving act feature amount extraction unit 251 extracts a high-accident-correlation driving act among driving acts obtained on the basis of driving state information of a driver who makes a request for a UI/UX image constituted by an evaluation image, among pieces of driving state information registered in the driving state DB 210, as a feature amount.

In step S82, the personal driving risk tendency calculation unit 252 calculates an occurrence probability, a degree of contribution, and a degree of risk for each high-accident-correlation driving act of each driver on the basis of information on the high-accident-correlation driving act extracted by the high-accident-correlation driving act feature amount extraction unit 251, and outputs the calculated information as a personal driving risk tendency.

In more detail, the personal driving risk tendency calculation unit 252 calculates an occurrence probability from the number of times of occurrence in a unit driving time, a unit mileage, and the like for each high-accident-correlation driving act of each driver, on the basis of the information on the high-accident-correlation driving act extracted by the high-accident-correlation driving act feature amount extraction unit 251.

In addition, the personal driving risk tendency calculation unit 252 performs regression analysis using an occurrence probability of an accident, the number of accidents, the amount of damages, and the like as objective variables on the basis of the information on the high-accident-correlation driving act extracted by the high-accident-correlation driving act feature amount extraction unit 251, and calculates the degree of contribution for each high-accident-correlation driving act.

Further, the personal driving risk tendency calculation unit 252 calculates a degree of risk by multiplying a product of an occurrence probability and a degree of contribution by a predetermined coefficient for each high-accident-correlation driving act.

In addition, the personal driving risk tendency calculation unit 252 outputs the occurrence probability, the degree of contribution, and the degree of risk for each high-accident-correlation driving act as a personal driving risk tendency of a driver who has made a request for a UI/UX image.

In step S83, the priority attention driving act selection unit 253 selects a high-accident-correlation driving act of which the risk degree is higher by a predetermined number as a priority attention driving act on the basis of information on a personal driving risk tendency, and outputs the selected high-accident-correlation driving act to the UI/UX image generation unit 208. In addition, the priority attention driving act selection unit 253 outputs information of the selected priority attention driving act to the average-occurrence-probability-of-all-contractors-for-priority-attention-driving-act extraction unit 255.

In step S84, the average-occurrence-probability-of-all-contractors-for-each-driving-act calculation unit 254 obtains an average occurrence probability for each of all high-accident-correlation driving acts in individual driving risk tendencies of all contractors, and outputs the obtained average occurrence probability to the average-occurrence-probability-of-all-contractors-for-priority-attention-driving-act extraction unit 255.

In step S85, the average-occurrence-probability-of-all-contractors-for-priority-attention-driving-act extraction unit 255 extracts an average occurrence probability of a priority attention driving act selected on the basis of a driving risk tendency of a driver among average occurrence probabilities of all high-accident-correlation driving acts of all contractors, and outputs the extracted average occurrence probability to the UI/UX image generation unit 208.

According to the above-described process, a driving risk tendency constituted by information on an occurrence probability, a degree of contribution, and a degree of risk for each priority attention driving act of a driver is obtained, occurrence probabilities of all contractors for each priority attention driving act are obtained, and the obtained driving risk tendency and occurrence probabilities are output to the UI/UX image generation unit 208.

In addition, information on a driving risk tendency is generated in this manner and supplied to the UI/UX image generation unit 208, so that a UI/UX image constituted by an evaluation image of driving of a driver himself or herself which is displayed on the mobile device 91 owned by the driver is generated.

Thereby, a driver can recognize a driving risk tendency by himself or herself by viewing a UI/UX image constituted by an evaluation image. In addition, a driver can not only confirm whether or not a discount of insurance premiums is received by viewing an evaluation image, but also can recognize how much attention should be paid to what kind of driving act in order for a discount of insurance premiums to be received in a case where a discount of insurance premiums is not received.

As a result, it is possible to improve consciousness of safe driving of a driver using an incentive such as a discount of insurance premiums and to suppress the occurrence of traffic accidents. In addition, it is possible to reduce the burden of insurance money on an insurer by suppressing the occurrence of traffic accidents, and thus it is possible to return insurance premiums to a driver who is an insurant by discounting insurance premiums.

Moreover, an example in which various detection results detected by the mobile device 91, the vehicle control unit 92, and the biological information detection unit 93 of the vehicle 73 are registered in the driving state DB 210, and a driving risk tendency is obtained on the basis of registered driving state information has been described above. However, driving state information may be registered on the basis of detection results detected by at least any one of the mobile device 91, the vehicle control unit 92, or the biological information detection unit 93.

In addition, it is possible to constitute driving state information only by detection results detected by the mobile device 91, and especially among these, it is possible to constitute driving state information only by detection results of positional information and accelerations detected by the GPS 133 and the acceleration sensor of the inertial sensor 134. Thereby, a UI/UX image generated on the basis of the obtained driving risk tendency can be displayed on the mobile device 91, and thus a configuration in which only the mobile device 91 is mounted on the vehicle 73 may be adopted. Further, the mobile device 91 may be configured to be provided with only the GPS 133 and the acceleration sensor of the inertial sensor 134.

That is, the information processing system 51 shown in FIG. 2 may be constituted by only the mobile device 91 carried by a driver who drives the vehicle 73 and the server 72. With such a configuration, the above-described information processing system 51 can be realized without providing a specific sensor in the vehicle 73. That is, for example, the mobile device 91 can realize the above-described functions only by installing application programs, and thus it is possible to easily realize the information processing system at low costs.

In addition, an example in which a UI/UX image is generated at a timing when a driver gets off the vehicle 73 and is displayed on the display unit 136 of the mobile device 91 has been described above, but other timings may be adopted.

That is, a timing when the UI/UX image is generated and displayed on the display unit 136 of the mobile device 91 may be, for example, a timing when a driver gets in a vehicle and a timing when a driver gets off a vehicle, a timing when a cumulative mileage exceeds a fixed value, a timing when a cumulative mileage from a timing when the last notification is given exceeds a fixed value, a timing when driving is terminated at a location registered as home, or the like, at least any one timing in a case where a driving action is significantly better than usual and a case where a driving action is significantly worse than usual, a timing when a Cash Back rate is updated, a timing when a target Cash Back rate is automatically updated, a timing when Cash Back can be applied, a timing when the insurance renewal month is approaching, a timing when a priority attention driving act is switched, and a timing when any one priority attention driving act falls below (exceeds) a target Cash Back rate, and may be at least any one timing of these timings.

Further, an example in which the present disclosure is realized by the information processing system 51 has been described above. However, for example, when the high function of the mobile device 91 can be realized, the mobile device 91 can be provided with functions using the server 72. In this case, various information DBs including the map information DB 203, the driving state DB 209, and the accident information DB 211 may be managed by a cloud server, and other functions using the server 72 may be realized by the mobile device 91.

### 3. Modification Example (Part 1)

Description has been given above of a display example of an evaluation image of a UI/UX image for promoting safe driving by displaying priority attention driving acts having a higher degree of risk as items and clearly showing a difference between a degree of risk of an individual driver and a reference for receiving a discount of insurance premiums to present a target for an incentive such as a discount of insurance premiums to a driver. However, the present disclosure is not limited thereto, and safe driving may be promoted by more clearly presenting an incentive such as a discount of insurance premiums to a driver.

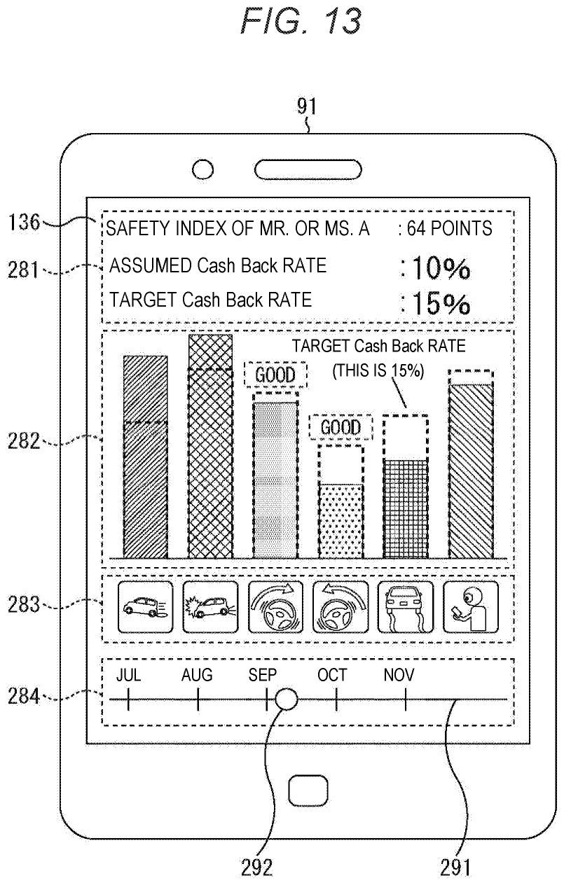

FIG. 13 shows a display example of a UI/UX image in a case where a graph obtained by comparing a safety index of an individual driver, an assumed Cash Back rate (assumed discount rate), a target Cash Back rate (target discount rate), and a degree of risk which is a reference for realizing a predetermined Cash Back rate with each other is displayed in time series.

In the display example of FIG. 13, a numerical value display column 281, a graph display column 282, a driving act item display column 283, and a time display column 284 are provided from the top.

A safety index, an assumed Cash Back rate, and a target Cash Back rate are displayed from the top in the numerical value display column 281. A graph is displayed in the graph display column 282. Icons for identifying priority attention driving acts corresponding to the graphs of the graph display column 282 are displayed in the driving act item display column 283. Times when evaluation items are set are displayed in the time display column 284.

In the numerical value display column 281 of FIG. 13, “Mr. or Ms. A's safety index: 64 points”, “assumed Cash Back rate: 10%”, and “target Cash Back rate: 15%” are written from the top, which indicates that a safety index of Mr. or Ms. A who is a driver is 64 points, an assumed Cash Back rate is 10%, and a target Cash Back rate is 15%. Here, the assumed Cash Back rate is a Cash Back rate which is assumed to be realized from a transition of the Cash Back rate so far. In addition, the target Cash Back rate is a Cash Back rate which is set for the assumed Cash Back rate, is a discount rate higher than the assumed Cash Back rate, and is a Cash Back rate being a target. Further, the safety index is a value which is set to be larger as, for example, a degree of risk decreases, and is set to be smaller as a degree of risk increases.

In the graph display column 282, bar graphs showing degrees of risk of a driver for driving acts shown as icons in the driving act item display column 283 and degrees of risk of all contractors are displayed.

In the case of FIG. 13, the icons displayed in the driving act item display column 283 represent sudden acceleration, sudden braking, sudden right steering, sudden left steering, unsteady driving, and inattentive driving from the left.

For this reason, the bar graphs displayed in the graph display column 282 are bar graphs indicating the degrees of risk of sudden acceleration, sudden braking, sudden right steering, sudden left steering, unsteady driving, and inattentive driving from the left in the drawing.

Further, in the graph display column 282, a patterned graph represents a degree of risk for each driving act of Mr. or Ms. A who is a driver, and a dotted graph represents a degree of risk being an index when the target Cash Back rate is 15%. That is, when the value of a colored graph corresponding to each driving act falls below a colored graph, 15% Cash Back is received.

Further, in the time display column 284, a pointer 292 is provided on a slide bar 291 in which July, August, . . . , and November are written from the left, and a time can be set by touching the display unit 136 functioning as a touch panel to slide the pointer 292 from side to side. In FIG. 13, the pointer 292 is set to be around the beginning of September, and the above-described display contents indicate around the beginning of September. That is, since various pieces of driving state information registered in the driving state DB 209 are registered in association with acquisition times, it is possible to display a driving risk tendency corresponding to a time (date and time) by obtaining information on a driving risk tendency from a high-accident-correlation driving act corresponding to an acquisition time designated by the pointer 292.

FIG. 13 shows evaluation for driving in the beginning of September of Mr. or Ms. A who is a driver. In FIG. 13, a safety index is 64 points, an assumed Cash Back rate is 10%, and a target Cash Back rate is 15%. In addition, degrees of risk for driving acts of sudden acceleration, sudden braking, sudden right steering, sudden left steering, unsteady driving, and inattentive driving of Mr. or Ms. A who is a driver are shown as patterned graphs. In the graph display column 282 shown in FIG. 13, the degrees of risk for sudden right steering and sudden left steering of the driver fall below respective target Cash Back rates, and thus “GOOD” is displayed above each of the graphs.

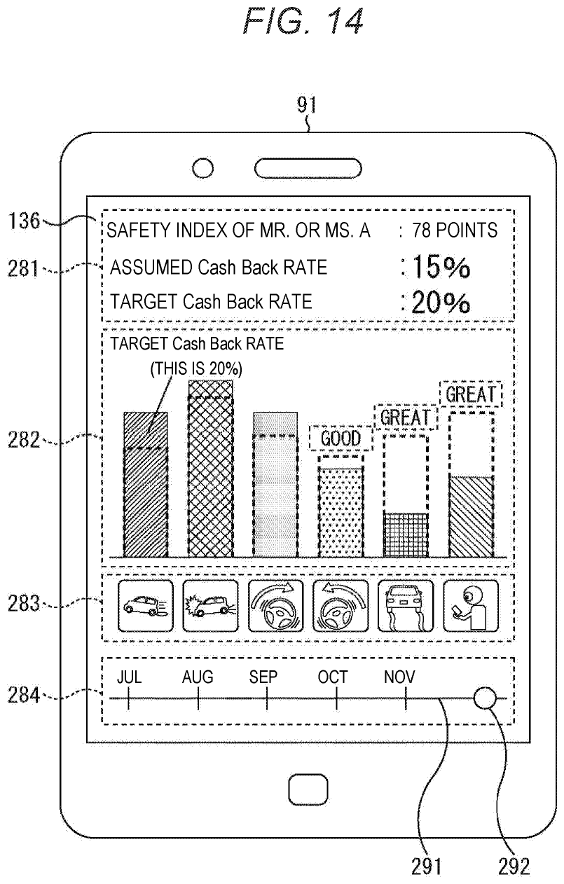

Since it is possible to change a time by sliding the pointer 292 from side to side, display contents are changed as shown in a numerical value display column 281 and a graph display column 282 shown in FIG. 14 when the pointer is moved to around the end of November, for example, as indicated by a pointer 292′ shown in FIG. 14.

That is, in FIG. 14, “Mr. or Ms. A's safety index: 78 points”, “assumed Cash Back rate: 15%”, and “target Cash Back rate: 20%” are written from the top, which indicates that a safety index of Mr. or Ms. A who is a driver is 78 points, an assumed Cash Back rate is 15%, and a target Cash Back rate is 20%.

Further, in the graph display column 282 shown in FIG. 14, a graph displayed as a patterned graph represents a degree of risk for each driving act of Mr. or Ms. A who is a driver, and a dashed graph represents a degree of risk when a target Cash Back rate is 20%.

In the graph display column 282 shown in FIG. 14, since a degree of risk for sudden left steering of the driver falls below a degree of risk to be an index of a target Cash Back rate, and thus “GOOD” is displayed above each of the graphs. In addition, degrees of risk for unsteady driving and inattentive driving of the driver significantly fall below respective degrees of risk to be target Cash Back rates, and thus “GREAT” is displayed.

That is, when comparing the display examples shown in FIGS. 13 and 14 with each other, a safety index has been improved by 14 points from the beginning of September to the end of November, and it is possible to cause the driver to recognize that the improvement can be achieved by setting a target Cash Back rate of 15% in September to be an assumed Cash Back rate of 15% in November for a driving act of sudden left steering.

In addition, a target Cash Back rate 20% being a new target is realized for sudden left steering, and it is possible to cause the driver to recognize that unsteady driving and inattentive driving can significantly fall below a target Cash Back rate 20%. Further, it is possible to realize that the driver may be preferably conscious of sudden acceleration, sudden braking, and sudden right steering in order to realize a target Cash Back rate 20%.

Thereby, it is possible to cause the driver to specifically recognize the degree of achievement of a target through an effort at a driving act in a predetermined period (for example, from the beginning of September shown in FIG. 13 to the end of November shown in FIG. 14) and to specifically recognize the next problem.

As a result, it is possible to improve the driver's consciousness of safe driving using an incentive such as a discount of insurance premiums (Cash Back rate).

Moreover, in the display examples shown in FIGS. 13 and 14, the examples in which target Cash Back rates are 15% and 20% have been described. However, a graph of a target Cash Back rate to be indicated as a dashed graph may be freely set to be various target Cash Back rates by a driver.

### 4. Modification Example (Part 2)

A display example of an evaluation image in which specific targets and degrees of achievement are expressed by graphs and numerical values has been described above, but safe driving may be promoted by clearly displaying driving acts to be noted.

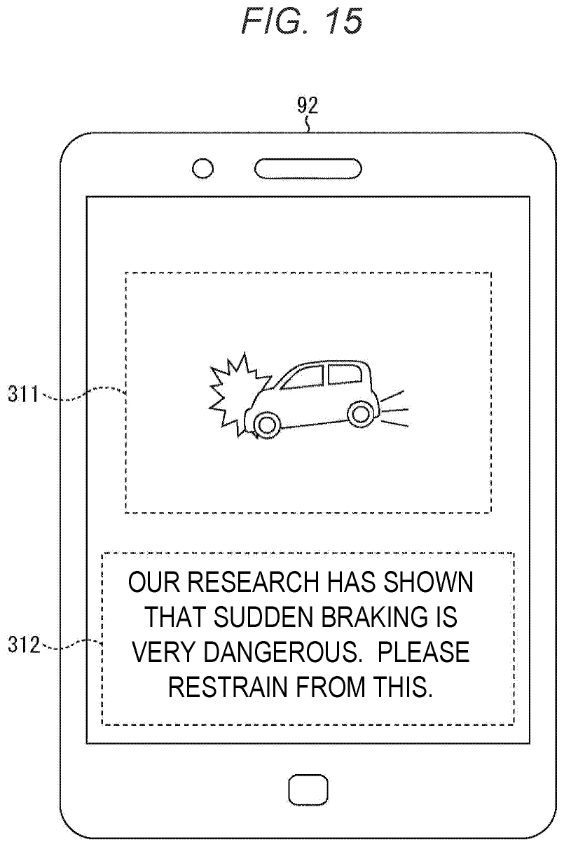

FIG. 15 shows a display example of a UI/UX image in which a driving act to be noted is clearly displayed.

In FIG. 15, a moving image display column 311 in which a moving image indicating a driving act in the first rank of a priority attention driving act is displayed is provided at the upper stage, and a comment column 312 for presenting a driving act in the first rank of a priority attention driving act is provided below the moving image display column.

In a case where a driving act in the first rank of a priority attention driving act is, for example, sudden braking in the moving image display column 311, a moving image for reminding a driver of, for example, a situation in which an accident is caused due to spinning assumed when the driver suddenly steps on a brake in a vehicle is presented.

In addition, here, a driving act in the first rank of a priority attention driving act is sudden braking, and thus “Our research has shown that sudden braking is very dangerous. Please restrain from this.” is displayed in the comment column 312. That is, it is clearly shown that sudden braking which is a driving act in the first rank of a priority attention driving act is dangerous and is restrained.

Thereby, it is possible to promote safe driving by causing a driver to specifically recognize a driving act in the first rank of a priority attention driving act at first sight and to pay attention to a driving act to be preferentially noted.

### 5. Modification Example (Part 3)

A display example of an evaluation image in which a driving act being a problem is specifically presented to a driver so as to be recognized by the driver has been described above, but safe driving may be promoted by effectively presenting a safety index.

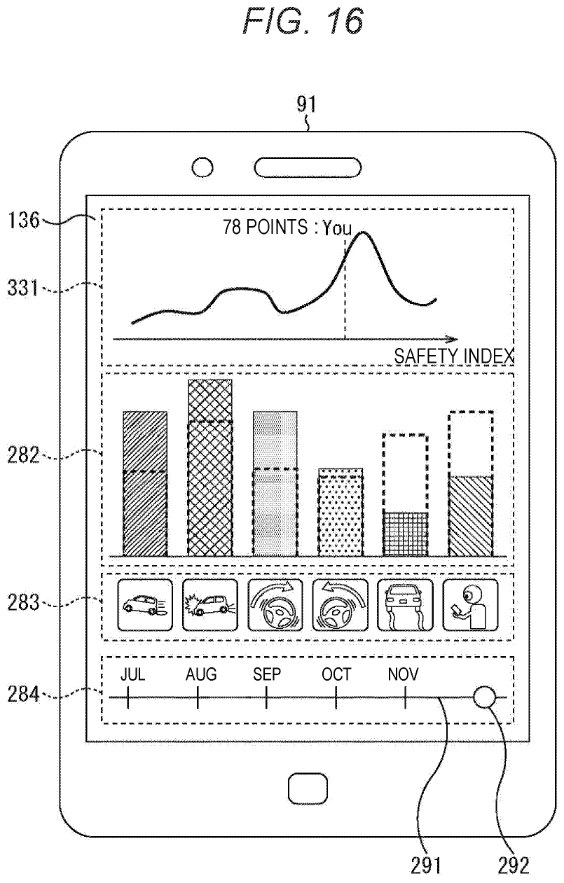

FIG. 16 shows a display example in which a safety index display column 331 is provided instead of the numerical value display column 281 in the display example shown in FIGS. 13 and 14.

In the safety index display column 331 shown in FIG. 16, a curved line obtained by smoothly connecting histograms of safety indexes of all contractors is displayed, and a safety index of a driver himself or herself is shown as a dashed line. In FIG. 16, a safety index of a driver is displayed as 78 points (You: 78 points). That is, in the histogram displayed in the safety index display column 331 shown in FIG. 16, a horizontal axis represents a safety index, and a vertical axis represents a frequency (the number of persons).

Since the rank of the driver's own safety index among all of the contractors becomes clear by performing display in this manner, it is possible to set a target for attaining a higher rank and to recognize how much the driver is conscious of safe driving among all of the contractors.

In addition, the rank of the safety index among all of the contractors is changed and displayed according to a time by moving the pointer 292 on the slide bar 291, and thus the driver can confirm a transition of the his or her own safety index according to a time.

Thereby, it is possible to cause a driver to recognize the rank of a safety index with respect to all contractors, and it is possible to quantitatively recognize the level of consciousness of the driver with respect to all of the contractors regarding an effort at safe driving. Also in this case, it is possible to cause the driver to specifically recognize the degree of achievement of a target through an effort at safe driving for each priority attention driving act and to specifically recognize the next problem.

### 6. Modification Example (Part 4)

A display example of an evaluation image for promoting safe driving by effectively presenting safety indexes has been described above. However, a driver may be caused to specifically recognize the degree of achievement of a target through an effort at safe driving for each priority attention driving act, and a driver may be caused to recognize a driving act being a problem which is specifically presented.

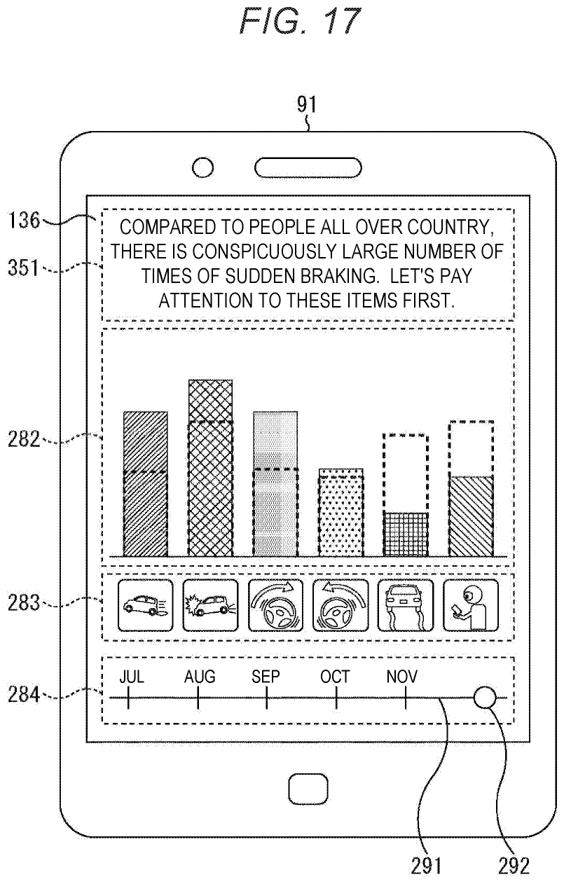

In FIG. 17, a comment display column 351 is provided instead of the numerical value display column 281 shown in FIGS. 13 and 14.

In the comment display column 351 of FIG. 17, “Compared to people all over the country, there is a conspicuously large number of times of sudden acceleration and sudden braking. Let's pay attention to these items first.” is written, and a driver can recognize that the degrees of risk of “sudden acceleration” and “sudden braking” as driving acts are higher than those of the other contractors and the driver himself or herself should pay attention to those driving acts.

Contents of a comment to be displayed in the comment display column 351 may be related to, for example, a priority attention driving act in which a difference between an occurrence probability of a priority attention driving act of a driver and an average occurrence probability of priority attention driving acts of all contractors is largest. In addition, contents of a comment to be displayed in the comment display column 351 may be related to, for example, a priority attention driving act in which a difference between a degree of risk of a priority attention driving act of a driver and an index of a target Cash Back rate is large.

Moreover, also in FIG. 17, driving acts to be noted are presented by moving a pointer 292 on a slide bar 291 to change a time and performing comparison between all contractors, and thus a driver can confirm a transition of a driving act to be noted by the driver himself or herself and can recognize an improvement in a driving act that has been noted, a driving act shown as a new problem, or the like as a change in the driving of the driver himself or herself.

### 7. Modification Example (Part 5)

A display example of an evaluation image for promoting safe driving by showing transitions of evaluation for a driving act of a driver so far has been described. However, for example, display for presenting points to be noted after traveling on a traveling route to a destination may be performed in conjunction with a navigation apparatus.

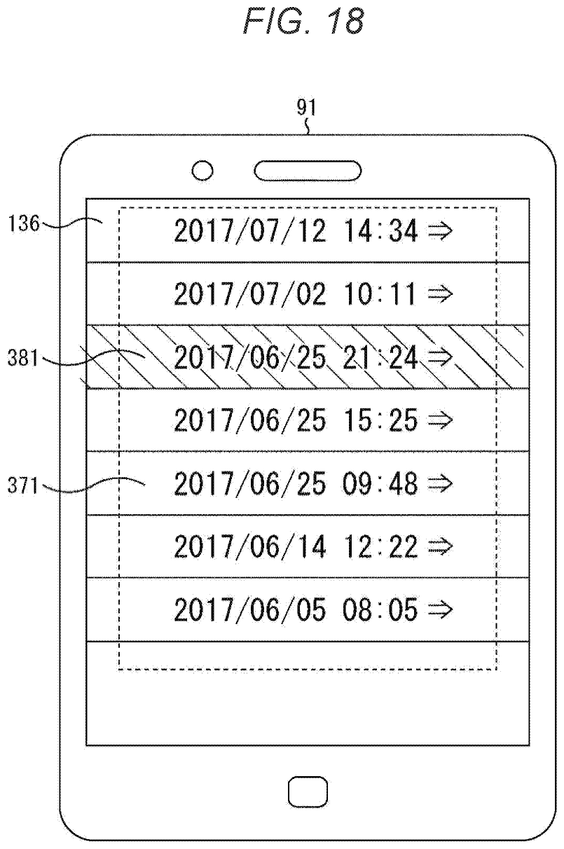

That is, for example, when a traveling route to a destination is set using a navigation apparatus, traveling records are left along the traveling route. In this manner, when the traveling records are left, a list of dates and times when traveling records are generated is displayed as a list display column 371 as shown in FIG. 18. In the list display column 371, colors corresponding to degrees of risk on the traveling route are shown. For example, a traveling route on a map is displayed in a red color for a traveling record regarded as being dangerous traveling in which a degree of risk higher than a predetermined value is obtained, and for example, a traveling route on the map may be displayed in blue for a traveling record regarded as being safe traveling in which a degree of risk lower than the predetermined value is obtained.

In the list display column 371 shown in FIG. 18, “2017/07/12 14:34”, “2017/07/02 10:11”, “2017/06/25 21:24”, “2017/06/25 15:25”, “2017/06/25 09:48”, “2017/06/14 12:22”, and “2017/06/05 08:05” are displayed from the top, which indicates that traveling records are recorded within a predetermined period from 14:34 on 2017/07/12.

In addition, it is indicated that traveling records are recorded within a predetermined period from 10:11 on 2017/07/02, within a predetermined period from 21:24 on 2017/06/25, within a predetermined period from 15:25 on 2017/06/25, within a predetermined period from 09:48 on 2017/06/25, within a predetermined period from 12:22 on 2017/06/14, and within a predetermined period from 08:05 on 2017/06/05.

For example, in the list display column 371 shown in FIG. 18, it is assumed that a date-and-time column 381 in which “2017/06/25 21:24” displayed as a right-downward inclined portion at a third stage from the top is written is displayed in red indicating a traveling record having a high degree of risk.

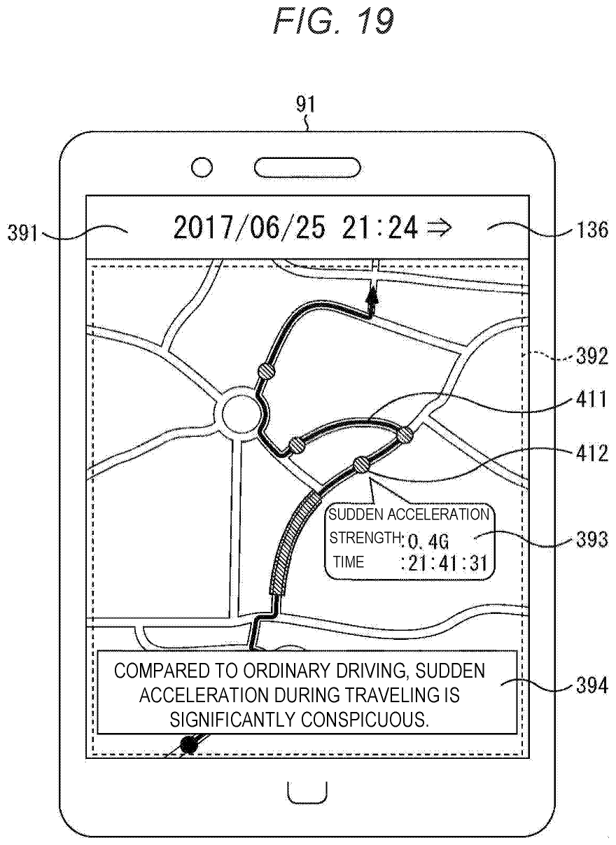

When the date-and-time column 381 is selected and operated in accordance with the function of the touch panel of the display unit 136, a map image indicating a traveling route obtained using a navigation apparatus is displayed as shown in FIG. 19.

In FIG. 19, a date-and-time display column 391 in which a date and time of selection are displayed is displayed in the uppermost portion, which indicates a traveling record of “2017/06/25 21:24” which is the traveling record selected in the date-and-time column 381 shown in FIG. 18.

A map display column 392 is provided below the date-and-time display column 391. In the map display column 392 shown in FIG. 19, a traveling route 411 is displayed in black, and the traveling route is displayed by a right-downward inclined line at a point where a high-accident-correlation driving act having a degree of risk higher than a predetermined value is performed on the traveling route.

Further, a writing column 393 for describing contents of a high-accident-correlation driving act when an operation is performed on a position which is indicated by a right-downward inclined line on the traveling route 411 and where the high-accident-correlation driving act is performed is provided, and the description of the high-accident-correlation driving act is displayed in a pop-up manner.

In FIG. 19, the writing column 393 is displayed in a pop-up manner in response to the operation of a circle mark 412. In the writing column 393, “sudden acceleration strength: 0.4 G time: 21:41:31” is written, which indicates that a high-accident-correlation driving act performed in the past at a point indicated by the circle mark 412 on the traveling route is sudden acceleration that occurred at 21:41:31, and a strength at that time was 0.4 G.

Further, a comment column 394 is provided below the map display column 392, and the reason why a degree of risk is higher than a predetermined value in the traveling records is written. In the comment column 394 shown in FIG. 19, a comment of “Compared to ordinary driving, sudden acceleration during traveling is significantly conspicuous.” is written, and it is indicated that the reason why the degree of risk is higher than the predetermined value is due to sudden acceleration.

A driver can confirm at what point and what kind of high-accident-correlation driving act has been performed by reviewing the traveling records, and can recognize what kind of driving act should be noted at what position and at what timing in the future.

Moreover, a display example of a comment in a traveling record in which a degree of risk is higher than a predetermined value has been described above. However, in the case of a traveling record regarded as being safe driving in which a degree of risk is lower than a predetermined value, a good point in traveling being safe driving may be commented in the comment column 394.

### 8. Example for Executing by Software

Incidentally, the series of the processes described above is able to be executed by hardware, but the series of the processes described above is also able to be executed by software. In a case in which the series of the processes is executed by software, a program included in the software is installed from a recording medium to a computer built into dedicated hardware, or for example, a general-purpose computer capable of executing various functions by installing various programs, or the like.

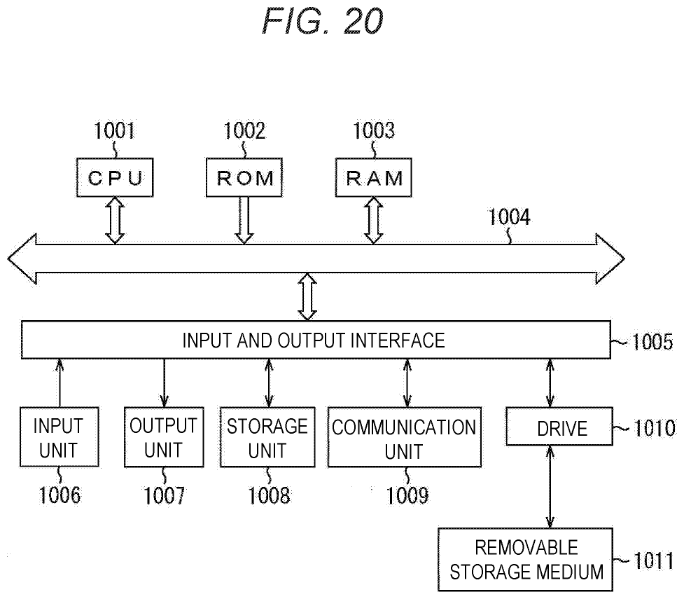

FIG. 20 shows a configuration example of a general-purpose computer. This personal computer has a central processing unit (CPU) 1001 built therein. An input and output interface 1005 is connected to the CPU 1001 through a bus 1004. A read only memory (ROM) 1002 and a random access memory (RAM) 1003 are connected to the bus 1004.

An input unit 1006 including an input device such as a keyboard and a mouse through which the user inputs an operation command, an output unit 1007 that outputs a process operation screen or an image of a process result to a display device, a storage unit 1008 that includes a hard disk drive or the like storing a program or various data, and a communication unit 1009 that includes a local area network (LAN) adapter or the like and executes a communication process through a network represented by the Internet are connected to the input and output interface 1005. In addition, a magnetic disk (including a flexible disk), an optical disk (including a compact disc-read only memory (CD-ROM) and a digital versatile disc (DVD)), a magneto-optical disk (including a mini disc (MD), a drive 1010 that reads and writes data from and to a removable medium 1011 such as a semiconductor memory is connected to the input and output interface 1005.

The CPU 1001 executes various processes according to the program stored in the ROM 1002 or the program that is read from the magnetic disk, the optical disk, the magneto-optical disk, or the removable medium 1011 such as a semiconductor memory, installed in the storage unit 1008, and loaded to the RAM 1003 from the storage unit 1008. The RAM 1003 also appropriately stores data necessary for the CPU 1001 to execute various processes, for example.

In the computer configured as described above, the CPU 1001 loads a program that is stored, for example, in the storage unit 1008 onto the RAM 1003 via the input and output interface 1005 and the bus 1004, and executes the program, thereby performing the above-described series of processes.

For example, programs to be executed by the computer (CPU 1001) can be recorded and provided in the removable medium 1011, which is a packaged medium or the like. In addition, programs can be provided via a wired or wireless transmission medium such as a local area network, the Internet, and digital satellite broadcasting.

In the computer, by mounting the removable medium 1011 onto the drive 1010, programs can be installed into the storage unit 1008 via the input and output interface 1005. Programs can also be received by the communication unit 1009 via a wired or wireless transmission medium, and installed into the storage unit 1008. In addition, programs can be installed in advance into the ROM 1002 or the storage unit 1008.

Note that a program executed by the computer may be a program in which processes are chronologically carried out in a time series in the order described herein or may be a program in which processes are carried out in parallel or at necessary timing, such as when the processes are called.

Moreover, the CPU 1001 shown in FIG. 20 realizes the function of the control unit 201 of the server 72 shown in FIG. 4. In addition, a storage unit 1008 shown in FIG. 20 realizes the map information DB 203, the driving state DB 209, and the accident information DB 211 shown in FIG. 4.

Further, in this specification, a system has the meaning of a set of a plurality of configuration elements (such as an apparatus or a module (part)), and does not take into account whether or not all the configuration elements are in the same casing. Therefore, the system may be either a plurality of apparatuses stored in separate casings and connected through a network, or an apparatus in which a plurality of modules is stored within a single casing.

Note that an embodiment of the present disclosure is not limited to the embodiments described above, and various changes and modifications may be made without departing from the scope of the present disclosure.

For example, the present disclosure can adopt a configuration of cloud computing, in which a plurality of devices shares a single function via a network and perform processes in collaboration.

Furthermore, each step in the above-described flowcharts can be executed by a single device or shared and executed by a plurality of devices.

In addition, in a case where a single step includes a plurality of processes, the plurality of processes included in the single step can be executed by a single device or shared and executed by a plurality of devices.

Additionally, the present technology may also be configured as below.

<1> An information processing apparatus including:

a driving act acquisition unit that acquires information on driving acts of a driver who drives a vehicle;

a high-accident-correlation driving act feature amount extraction unit that extracts a high-accident-correlation driving act that is highly correlated to an accident among the driving acts;

a driving risk tendency calculation unit that calculates a driving risk tendency on the basis of the high-accident-correlation driving act; and a display image generation unit that generates a display image on the basis of the driving risk tendency calculated by the driving risk tendency calculation unit.

<2> The information processing apparatus according to <1>, in which

the driving risk tendency calculation unit calculates an occurrence probability, a degree of contribution, and a degree of risk of the high-accident-correlation driving act as driving risk tendencies.

<3> The information processing apparatus according to <2>, in which

the driving risk tendency calculation unit calculates an occurrence probability of the high-accident-correlation driving act in units of time or units of mileage, calculates a degree of contribution by regression analysis of the high-accident-correlation driving act in the units of time or the units of mileage, and calculates a degree of risk on the basis of a product of the occurrence probability and the degree of contribution.

<4> The information processing apparatus according to <3>, further including:

a priority attention driving act selection unit that selects a high-accident-correlation driving act of which a degree of risk is in a predetermined higher rank as a priority attention driving act.

<5> The information processing apparatus according to <4>, in which

the driver is a contractor to automobile insurance, and

the information processing apparatus further includes

an all-contractors high-accident-correlation driving act average occurrence probability calculation unit that calculates an average occurrence probability of high-accident-correlation driving acts of all contractors to the automobile insurance, and

an all-contractors priority-attention-driving-act average occurrence probability extraction unit that extracts an average occurrence probability of all of the contractors for the priority attention driving act on the basis of the average occurrence probability of the high-accident-correlation driving acts of all of the contractors to the automobile insurance.

<6> The information processing apparatus according to <2>, in which

the driver is a contractor to automobile insurance, and

the display image generation unit generates a display image on the basis of a degree of risk of a priority attention driving act in the driving risk tendency.

<7> The information processing apparatus according to <6>, in which

the display image generation unit generates a display image indicating comparison between the degree of risk of the priority attention driving act in the driving risk tendency and a degree of risk corresponding to a discount rate of insurance premiums of the automobile insurance.

<8> The information processing apparatus according to <7>, in which

the display image generation unit generates a display image in which a comment for promoting improvement in a driving act is added for a priority attention driving act in which the degree of risk of the priority attention driving act in the driving risk tendency is lower than a degree of risk that is an index of the discount rate of insurance premiums of the automobile insurance.

<9> The information processing apparatus according to <8>, in which

the discount rate of insurance premiums is set on the basis of a function indicating that the discount rate becomes lower as the degree of risk increases and the discount rate becomes higher as the degree of risk decreases.

<10> The information processing apparatus according to <7>, in which

the display image generation unit sets a safety index on the basis of the degree of risk of the priority attention driving act and generates a display image in which the safety index is added.

<11> The information processing apparatus according to <7>, in which

the display image generation unit includes a configuration having a date-and-time designation function for designating a date and time in a display image and generates the display image indicating comparison between the degree of risk of the priority attention driving act in the driving risk tendency and a degree of risk according to the discount rate of insurance premiums of the automobile insurance at the date and time designated using the date-and-time designation function.

<12> The information processing apparatus according to <7>, in which

the display image generation unit generates a display image in which a moving image for promoting an improvement in a driving act is added for a priority attention driving act in which the degree of risk of the priority attention driving act in the driving risk tendency is lower than a degree of risk that is an index of the discount rate of insurance premiums of the automobile insurance.

<13> The information processing apparatus according to <7>, in which

the display image generation unit generates a display image of a traveling route of the vehicle driven by the driver and generates a display image in which a position having a degree of risk higher than a predetermined degree of risk is displayed in a predetermined color on the traveling route on the basis of information on the driving risk tendency.

<14> The information processing apparatus according to any one of <1> to <13>, further including:

a driving state accumulation unit that extracts information on driving acts of the driver who drives the vehicle and accumulates detection results of driving states of the driver;

a map information acquisition unit that acquires positional information of the vehicle driven by the driver, extracts map information based on the positional information, and accumulates the extracted information in the driving state accumulation unit as the driving states;

an action information acquisition unit that detects action information of the vehicle driven by the driver and accumulates the detected information in the driving state accumulation unit as the driving state;

a vehicle inside and outside image information acquisition unit that detects vehicle inside and outside image information of the vehicle driven by the driver and accumulates the detected information in the driving state accumulation unit as the driving state; and

a biological information acquisition unit that detects biological information of the driver and accumulates the detected information in the driving state accumulation unit as the driving state.

<15> The information processing apparatus according to <14>, in which

the positional information is detected by a mobile device carried by the driver, and

the information processing apparatus further includes a transmission unit that transmits the display image generated by the display image generation unit to the mobile device carried by the driver.

<16> An information processing method including:

a driving act acquiring process of acquiring information on driving acts of a driver who drives a vehicle;

a high-accident-correlation driving act extraction process of extracting a high-accident-correlation driving act that is highly correlated to an accident among the driving acts;

a driving risk tendency calculation process of calculating a driving risk tendency on the basis of the high-accident-correlation driving act; and

a display image generation process of generating a display image on the basis of the driving risk tendency calculated by the driving risk tendency calculation process.

<17> A program for causing a computer to function as:

a driving act acquisition unit that acquires information on driving acts of a driver who drives a vehicle;

a high-accident-correlation driving act feature amount extraction unit that extracts a high-accident-correlation driving act that is highly correlated to an accident among the driving acts;

a driving risk tendency calculation unit that calculates a driving risk tendency on the basis of the high-accident-correlation driving act; and

a display image generation unit that generates a display image on the basis of the driving risk tendency calculated by the driving risk tendency calculation unit.

<18> An information processing apparatus that is carried by a driver who drives a vehicle, the information processing apparatus including:

a position detection unit that detects positional information of the vehicle;

a detection unit that detects an acceleration of the vehicle; and

a communication unit that transmits the positional information and acceleration information to a server and acquires a display image generated by the server on the basis of the positional information and acceleration information, in which

the display image is generated on the basis of a driving risk tendency that is calculated from a high-accident-correlation driving act that is highly correlated to an accident among driving acts of the driver who drives the vehicle.

<19> An information processing method for an information processing apparatus that is carried by a driver who drives a vehicle, the information processing method including:

a positional information detection process of detecting positional information of the vehicle;

a detection process of detecting an acceleration of the vehicle; and

a communication process of transmitting the positional information and acceleration information to a server and acquiring a display image generated by the server on the basis of the positional information and acceleration information, in which

the display image is

generated on the basis of a driving risk tendency that is calculated from a high-accident-correlation driving act that is highly correlated to an accident among driving acts of the driver who drives the vehicle.

<20> A program for causing a computer that controls an information processing apparatus carried by a driver who drives a vehicle to function as:

a position detection unit that detects positional information of the vehicle;

a detection unit that detects an acceleration of the vehicle; and

a communication unit that transmits the positional information and acceleration information to a server and acquires a display image generated by the server on the basis of the positional information and acceleration information, in which

the display image is generated on the basis of a driving risk tendency that is calculated from a high-accident-correlation driving act that is highly correlated to an accident among driving acts of the driver who drives the vehicle.

### REFERENCE SIGNS LIST

51 Information processing system
71 Network
72 Server
73, 73-1 to 73-n Vehicle
91, 91-1 to 91-n Mobile device
92, 92-1 to 92-n Vehicle control unit
93 Biological information detection unit
131 Control unit
132 Communication unit
133 GPS
134 Inertial sensor
135 Environment sensor
151 Control unit
152 Communication unit
153 Vehicle information detection unit
154 Vehicle interior image detection unit
155 Vehicle exterior image detection unit
171 Control unit
172 Communication unit
173 Biological sensor
201 Control unit
202 Surrounding map information acquisition unit
203 Map information DB
204 Action information acquisition unit
205 Vehicle inside and outside image information acquisition unit
206 Biological information detection unit
207 Communication unit
208 UI/UX image generation unit
209 Driving state DB
210 Accident correlation extraction unit
211 Accident information DB
251 High-accident-correlation driving act feature amount extraction unit
252 Personal driving risk tendency calculation unit
253 Priority attention driving act selection unit
254 Average-occurrence-probability-of-all-contractors-for-each-driving-act calculation unit
255 Average-occurrence-probability-of-all-contractors-for-priority-attention-driving-act extraction unit

1. An information processing apparatus comprising:
a driving act acquisition unit that acquires information on driving acts of a driver who drives a vehicle;
a high-accident-correlation driving act feature amount extraction unit that extracts a high-accident-correlation driving act that is highly correlated to an accident among the driving acts;
a driving risk tendency calculation unit that calculates a driving risk tendency on a basis of the high-accident-correlation driving act; and
a display image generation unit that generates a display image on a basis of the driving risk tendency calculated by the driving risk tendency calculation unit.

2. The information processing apparatus according to claim 1, wherein
the driving risk tendency calculation unit calculates an occurrence probability, a degree of contribution, and a degree of risk of the high-accident-correlation driving act as driving risk tendencies.

3. The information processing apparatus according to claim 2, wherein
the driving risk tendency calculation unit calculates an occurrence probability of the high-accident-correlation driving act in units of time or units of mileage, calculates a degree of contribution by regression analysis of the high-accident-correlation driving act in the units of time or the units of mileage, and calculates a degree of risk on a basis of a product of the occurrence probability and the degree of contribution.

4. The information processing apparatus according to claim 3, further comprising:
a priority attention driving act selection unit that selects a high-accident-correlation driving act of which a degree of risk is in a predetermined higher rank as a priority attention driving act.

5. The information processing apparatus according to claim 4, wherein
the driver is a contractor to automobile insurance, and
the information processing apparatus further includes an all-contractors high-accident-correlation driving act average occurrence probability calculation unit that calculates an average occurrence probability of high-accident-correlation driving acts of all contractors to the automobile insurance, and
an all-contractors priority-attention-driving-act average occurrence probability extraction unit that extracts an average occurrence probability of all of the contractors for the priority attention driving act on a basis of the average occurrence probability of the high-accident-correlation driving acts of all of the contractors to the automobile insurance.

6. The information processing apparatus according to claim 2, wherein
the driver is a contractor to automobile insurance, and
the display image generation unit generates a display image on a basis of a degree of risk of a priority attention driving act in the driving risk tendency.

7. The information processing apparatus according to claim 6, wherein
the display image generation unit generates a display image indicating comparison between the degree of risk of the priority attention driving act in the driving risk tendency and a degree of risk corresponding to a discount rate of insurance premiums of the automobile insurance.

8. The information processing apparatus according to claim 7, wherein
the display image generation unit generates a display image in which a comment for promoting improvement in a driving act is added for a priority attention driving act in which the degree of risk of the priority attention driving act in the driving risk tendency is lower than a degree of risk that is an index of the discount rate of insurance premiums of the automobile insurance.

9. The information processing apparatus according to claim 8, wherein
the discount rate of insurance premiums is set on a basis of a function indicating that the discount rate becomes lower as the degree of risk increases and the discount rate becomes higher as the degree of risk decreases.

10. The information processing apparatus according to claim 7, wherein
the display image generation unit sets a safety index on a basis of the degree of risk of the priority attention driving act and generates a display image in which the safety index is added.

11. The information processing apparatus according to claim 7, wherein
the display image generation unit includes a configuration having a date-and-time designation function for designating a date and time in a display image and generates the display image indicating comparison between the degree of risk of the priority attention driving act in the driving risk tendency and a degree of risk according to the discount rate of insurance premiums of the automobile insurance at the date and time designated using the date-and-time designation function.

12. The information processing apparatus according to claim 7, wherein
the display image generation unit generates a display image in which a moving image for promoting an improvement in a driving act is added for a priority attention driving act in which the degree of risk of the priority attention driving act in the driving risk tendency is lower than a degree of risk that is an index of the discount rate of insurance premiums of the automobile insurance.

13. The information processing apparatus according to claim 7, wherein
the display image generation unit generates a display image of a traveling route of the vehicle driven by the driver and generates a display image in which a position having a degree of risk higher than a predetermined degree of risk is displayed in a predetermined color on the traveling route on a basis of information on the driving risk tendency.

14. The information processing apparatus according to claim 1, further comprising:
a driving state accumulation unit that extracts information on driving acts of the driver who drives the vehicle and accumulates detection results of driving states of the driver;
a map information acquisition unit that acquires positional information of the vehicle driven by the driver, extracts map information based on the positional information, and accumulates the extracted information in the driving state accumulation unit as the driving states;
an action information acquisition unit that detects action information of the vehicle driven by the driver and accumulates the detected information in the driving state accumulation unit as the driving state;
a vehicle inside and outside image information acquisition unit that detects vehicle inside and outside image information of the vehicle driven by the driver and accumulates the detected information in the driving state accumulation unit as the driving state; and
a biological information acquisition unit that detects biological information of the driver and accumulates the detected information in the driving state accumulation unit as the driving state.

15. The information processing apparatus according to claim 14, wherein
the positional information is detected by a mobile device carried by the driver, and
the information processing apparatus further includes a transmission unit that transmits the display image generated by the display image generation unit to the mobile device carried by the driver.

16. An information processing method comprising:
a driving act acquiring process of acquiring information on driving acts of a driver who drives a vehicle;
a high-accident-correlation driving act extraction process of extracting a high-accident-correlation driving act that is highly correlated to an accident among the driving acts;
a driving risk tendency calculation process of calculating a driving risk tendency on a basis of the high-accident-correlation driving act; and
a display image generation process of generating a display image on a basis of the driving risk tendency calculated by the driving risk tendency calculation process.

17. A program for causing a computer to function as:
a driving act acquisition unit that acquires information on driving acts of a driver who drives a vehicle;
a high-accident-correlation driving act feature amount extraction unit that extracts a high-accident-correlation driving act that is highly correlated to an accident among the driving acts;
a driving risk tendency calculation unit that calculates a driving risk tendency on a basis of the high-accident-correlation driving act; and
a display image generation unit that generates a display image on a basis of the driving risk tendency calculated by the driving risk tendency calculation unit.

18. An information processing apparatus that is carried by a driver who drives a vehicle, the information processing apparatus comprising:
a position detection unit that detects positional information of the vehicle;
a detection unit that detects an acceleration of the vehicle; and
a communication unit that transmits the positional information and acceleration information to a server and acquires a display image generated by the server on a basis of the positional information and acceleration information, wherein
the display image is generated on a basis of a driving risk tendency that is calculated from a high-accident-correlation driving act that is highly correlated to an accident among driving acts of the driver who drives the vehicle.

19. An information processing method for an information processing apparatus that is carried by a driver who drives a vehicle, the information processing method comprising:
a positional information detection process of detecting positional information of the vehicle;
a detection process of detecting an acceleration of the vehicle; and
a communication process of transmitting the positional information and acceleration information to a server and acquiring a display image generated by the server on a basis of the positional information and acceleration information, wherein
the display image is
generated on a basis of a driving risk tendency that is calculated from a high-accident-correlation driving act that is highly correlated to an accident among driving acts of the driver who drives the vehicle.

20. A program for causing a computer that controls an information processing apparatus carried by a driver who drives a vehicle to function as:
a position detection unit that detects positional information of the vehicle;
a detection unit that detects an acceleration of the vehicle; and
a communication unit that transmits the positional information and acceleration information to a server and acquires a display image generated by the server on a basis of the positional information and acceleration information, wherein
the display image is generated on a basis of a driving risk tendency that is calculated from a high-accident-correlation driving act that is highly correlated to an accident among driving acts of the driver who drives the vehicle.
